(19) United States
(12) Patent Application Publication
(10) Pub. No.: US 2022/0368644 A1
(43) Pub. Date: Nov. 17, 2022

(54) INFORMATION PROCESSING APPARATUS, INFORMATION PROCESSING METHOD, AND COMPUTER-READABLE RECORDING MEDIUM STORING INFORMATION PROCESSING PROGRAM

(71) Applicant: FUJITSU LIMITED, Kawasaki-shi (JP)

(72) Inventor: Jun KATO, Kawasaki (JP)

(73) Assignee: FUJITSU LIMITED, Kawasaki-shi (JP)

(21) Appl. No.: 17/702,332

(22) Filed: Mar. 23, 2022

(30) Foreign Application Priority Data
May 13, 2021 (JP) 2021-081668
Jan. 5, 2022 (JP) 2022-000771

(51) Int. Cl. H04L 47/41; H04L 47/2441; H04L 47/27; H04L 49/9005

(52) U.S. Cl. CPC H04L 47/41; H04L 47/2441; H04L 47/27; H04L 49/9005

(57) ABSTRACT

An information processing apparatus including: a memory; and a processor coupled to the memory, the processor being configured to perform processing including: executing a buffer management processing that, under flow control over communication executed by an arithmetic processing device, sequentially obtains a plurality of packets transmitted and destined for the arithmetic processing device, stores the packets in a buffer, generates one aggregated packet by aggregating the packets, and transmits the aggregated packet to the arithmetic processing device; executing an ACK management processing that decides transmission timing for ACKs to a transmission source of the packets based on a flow rate for the aggregated packet; and executing a window management processing that decides a receive window size representing a data amount to be transmitted by one flow to the arithmetic processing device based on the flow rate for the aggregated packet.

### CROSS-REFERENCE TO RELATED APPLICATION

This application is based upon and claims the benefit of priority of the prior Japanese Patent Application Nos. 2022-771, filed on Jan. 5, 2022, and 2021-81668, filed on May 13, 2021, the entire contents of which are incorporated herein by reference.

### FIELD

The embodiments discussed herein are related to an information processing apparatus, an information processing method, and a computer-readable recording medium storing an information processing program.

### BACKGROUND

A virtual environment called a “container” has received attention which collectively contains a body of an application and a start-up environment for the application including a library, a setting file and so on to be used on a host operating system (OS). A plurality of containers generally operates on a host computer such as a server or the like. In a system having containers, a plurality of host computers in which the containers operate may be coupled in some cases.

For setting and managing the system having such containers, a network interface between the containers is often defined by a container network interface (CNI). At a time when a container is generated, is deleted or the like, a CNI-based plug-in generates a flow rule to be used for communication between containers arranged in each of the host computers from an arrangement of each of the containers and sets the generated flow rule to each virtual switch. In a system having containers, packet transfer is performed based on each flow rule set to each of virtual switches.

In recent years, a technology has been provided which offloads a virtual switch to a smart network interface card (NIC). The smart NIC is a communication control device that executes Internet Protocol (IP) packet processing or the like instead of a central processing unit (CPU). By moving the function corresponding to a virtual switch to the smart NIC, a container is able to occupy the CPU in the host computer. In offloading to this smart NIC, the function of the virtual switch is divided into two roles as an embedded switch that performs packet transfer processing by hardware and a controller in software that performs rule management in the CPU over the smart NIC.

In the smart NIC, a flow is processed in accordance with the flow rule. The term “flow” refers to a flow of a data set in each communication. Upon arrival of a packet, the smart NIC executes an action in the flow which matches the flow rule. As a flow rule, there are a rule that transfers a packet to a specific port when a destination media access control (MAC) address is a predetermined number and a rule that causes a packet to be dropped when the Transmission Control Protocol (TCP) destination port is 22.

When the embedded switch does not have a cache for a flow rule, the embedded switch inquires at the controller about the flow rule, caches the result, and transfers a packet in accordance with the flow rule. On the other hand, when the embedded switch has a cache for a flow rule, the embedded switch transfers a packet in accordance with the cached flow rule. Hardware processing which does not include software processing is performed when an embedded switch has a cache for a flow rule, the embedded switch may quickly perform packet transfer processing.

In operating a system in which containers operate by using the smart NIC, achievement of goals as follows is strongly demanded. One goal is to increase the rate of aggregation of containers to bring the usage rate of the CPU closer to 100% in order to reduce total cost of ownership (TCO). Another goal is to attempt delay reduction by giving a priority level to each of the containers and allocating the CPU and the network by priority to a container with a higher priority level and thus achieve low delay processing. Another goal is to effectively make the smart NIC available also to the components other than the CPU in the host computer.

As a technology for network control using a smart NIC or the like, a function called large receive offload (LRO) has been proposed which reconstructs a received packet to a larger packet. For example, a technology has been proposed which aggregates a plurality of TCP segments into one with a hardware NIC by LRO and feeds it to a higher layer. Since the number of TCP segments to be processed by the host computer is thus reduced, the number of interrupts decreases, which reduces the processing load of the TCP. However, the number of TCP segments to be aggregated by LRO is generally a fixed value because the aggregation is performed by hardware processing by the NIC. A technology has been proposed which performs communication by deciding a receive window size based on a congestion window size for a jumbo packet generated by coupling payloads by LRO functionality. A technology has been proposed which relates to a smart NIC that has a buffer for a flow packet and processes a flow by using a congestion notification or the like. A technology has been proposed which performs congestion control by adjusting a TCP parameter in accordance with a state of a network.

Examples of the related art include as follows: Japanese Laid-open Patent Publication No. 2019-205064; U.S. Patent Application Publication No. 2016/0380896; and U.S. Patent Application Publication No. 2018/0205656.

Examples of the related art further include Implementation of TCP Large Receive Offload on Multi-core NPU Platform, Li et. al, International Conference on Information and Communication Technology Convergence (ICTC), 19-21 Oct. 2016.

### SUMMARY

According to an aspect of the embodiments, there is provided an information processing apparatus including: a memory; and a processor coupled to the memory, the processor being configured to perform processing. In an example, the processing includes: executing a buffer management processing that, under flow control over communication executed by an arithmetic processing device, sequentially obtains a plurality of packets transmitted and destined for the arithmetic processing device, stores the packets in a buffer, generates one aggregated packet by aggregating the packets, and transmits the aggregated packet to the arithmetic processing device; executing an ACK management processing that decides transmission timing for ACKs to a transmission source of the packets based on a flow rate for the aggregated packet; and executing a window management processing that decides a receive window size representing a data amount to be transmitted by one flow to the arithmetic processing device based on the flow rate for the aggregated packet.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an information processing system according to an embodiment;

FIG. 2 illustrates a flow of a packet in a state where flow control has not been started;

FIG. 3 illustrates a flow of a packet when flow control occurs;

FIG. 4 illustrates a state of a packet when flow control occurs;

FIG. 5 illustrates a flow of an ACK when flow control occurs;

FIG. 6 is a flowchart of flow rate limit control processing;

FIG. 7 is a flowchart of processing of deciding ACK timing and a receive window size in an inflow rate increasing mode;

FIG. 8 is a flowchart of processing of deciding ACK timing and a receive window size in an inflow rate reducing mode;

FIG. 9 is a flowchart of ACK transmission processing;

FIG. 10 is a hardware configuration diagram of a server;

FIG. 11 is a block diagram illustrating an information processing system according to Embodiment 2;

FIG. 12 illustrates an example of dynamic flow rate adjustment;

FIG. 13 is a first diagram illustrating a comparison between a case where latency reduction processing is performed and a case where the processing is not performed;

FIG. 14 is a second diagram illustrating a comparison between a case where latency reduction processing is performed and a case where the processing is not performed;

FIG. 15 is a third diagram illustrating a comparison between a case where latency reduction processing is performed and a case where the processing is not performed;

FIG. 16 is a first diagram illustrating a comparison between a case where dynamic flow rate adjustment is performed and a case where the adjustment is not performed;

FIG. 17 is a second diagram illustrating a comparison between a case where dynamic flow rate adjustment is performed and a case where the adjustment is not performed;

FIG. 18 is a flowchart of flow rate limit control processing to which the latency reduction processing is added;

FIG. 19 is a flowchart of packet retrieval processing;

FIG. 20 is a flowchart of processing to be performed when packets are received by a container; and

FIG. 21 is a flowchart of the dynamic flow rate adjustment processing.

### DESCRIPTION OF EMBODIMENTS

However, in a situation where, in a system in which containers using a smart NIC operate, processing is performed on the containers each having a priority level, burst traffic destined for a container having a lower priority level may occur in some cases. In such a case, an interrupt occurs for each of packets included in the burst traffic, and the CPU is consumed by processing on the interrupts, making the passing of the burst traffic difficult. It may be considered that processing on a container having a higher priority level may be hindered by the processing on interrupts destined for a container having a low priority level. For that, when a smart NIC is used, it is difficult to effectively utilize resource in arithmetic processing or the like on a flow.

Although LRO functionality may couple packets for increasing the speed of processing received packets, it is difficult to reduce the effect of interrupts caused by burst traffic in association with the flow control according to the priority levels. Similarly, even when a technology is used which performs communication with a receive window size decided based on the congestion window size for a jumbo packet, it is difficult to reduce the effect of interrupts caused by burst traffic in association with the time when flow control according to the priority levels is performed. Even with the technology relating to a smart NIC that processes a flow by using a congestion notification or the like or the technology that performs congestion control by adjusting a TCP parameter in accordance with the state of a network, it is difficult to realize the reduction of the number of interrupts when burst traffic occurs. Therefore, even by using any of the technologies, effective utilization of resource in arithmetic processing or the like on a flow is difficult when a smart NIC is employed and flow control according to priority levels is performed.

The technology of the present disclosure is devised in consideration of the above-mentioned circumstances, and it is an object of the present disclosure to provide an information processing apparatus, an information processing method, and an information processing program that effectively utilize resource when a smart NIC is used.

Hereinafter, embodiments of an information processing apparatus, an information processing method, and an information processing program disclosed in this application will be described in detail based on the drawings. The information processing apparatus, information processing method, and information processing program disclosed in this application are not limited by the following embodiments.

### Embodiment 1

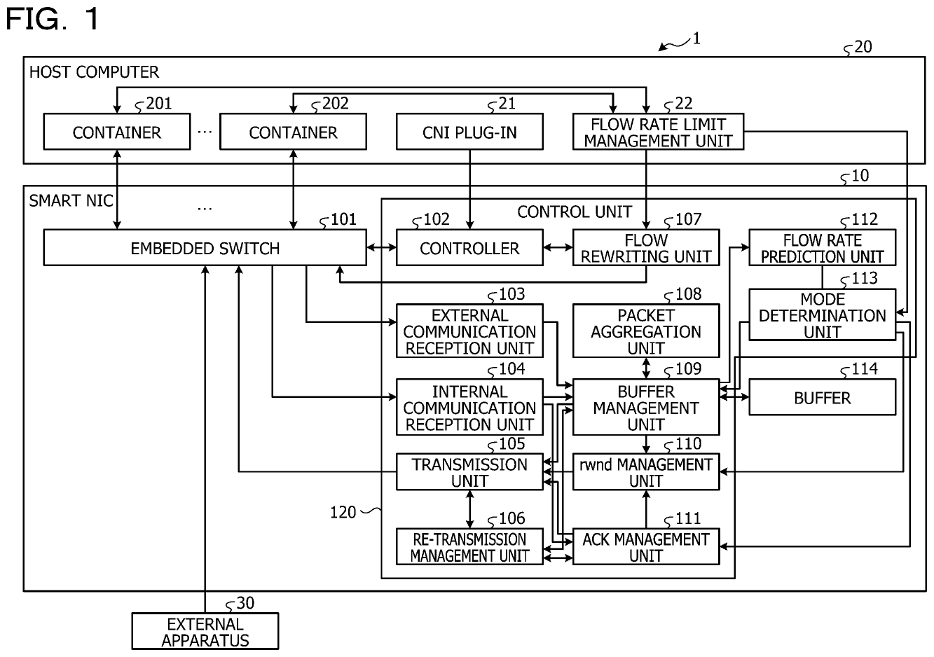

FIG. 1 is a block diagram illustrating an information processing system according to an embodiment. As illustrated in FIG. 1, an information processing system 1 includes a smart NIC 10 and a host computer 20. The smart NIC 10 may be internally contained in the host computer 20.

The host computer 20 has a plurality of containers including containers 201 and 202 corresponding to an example of an arithmetic processing device. Hereinafter, each of the containers including the containers 201 and 202 will be called a “container 200” if the containers are not distinguished from each other. The host computer 20 has a CNI plug-in 21 and a flow rate limit management unit 22.

At a time when the container 200 is generated, is deleted, or the like, the CNI plug-in 21 generates a flow rule to be used for communication between containers arranged in each of the host computers from an arrangement of each of the containers. The CNI plug-in 21 transmits the generated flow rule to a controller 102 in the smart NIC 10 and sets the flow rule.

The flow rate limit management unit 22 stores a priority level of each of the containers 200. For example, the flow rate limit management unit 22 stores information on a quality of service (QoS) against a CPU usage rate set in each of the containers 200. The flow rate limit management unit 22 decides the CPU usage rate of each of the containers 200 in accordance with the QoS. After that, the flow rate limit management unit 22 measures an actual CPU usage rate and calculates a receive flow rate limit value for each of the containers 200. For example, the flow rate limit management unit 22 sets the receive flow rate limit value higher for a container 200 with a higher priority level for which a higher QoS is set and sets the receive flow rate limit value lower for a container 200 with a lower priority level for which a low QoS is set. The flow rate limit management unit 22 acquires an actual inflow rate for a packet destined for each of the containers 200.

The flow rate limit management unit 22 determines to execute flow control over a certain container 200 when the inflow rate for packets destined for the certain container 200 is greater than or equal to the receive flow rate limit value. The flow rate limit management unit 22 instructs a flow rewriting unit 107 to execute the flow control over the certain container 200. The receive flow rate limit value is notified to the certain container 200 for which the execution of flow control is decided and causes the container 200 to execute the flow control. The flow rate limit management unit 22 outputs the information on the receive flow rate limit value to a mode determination unit 113 in the smart NIC 10.

After that, when the inflow rate for packets destined for the certain container 200 for which the flow control is performed is lower than the receive flow rate limit value, the flow rate limit management unit 22 executes the following processing. For example, the flow rate limit management unit 22 waits for completion of processing of all packets which are stored in a buffer 114 and destined for the certain container 200. After that, the flow rate limit management unit 22 notifies the flow rewriting unit 107 of an instruction to return the flow rule for transmission of packets destined for the certain container 200 to the original flow rule. Thus, an embedded switch 101 is caused to transfer packets directly to the certain container 200.

Flow control is executed for each container 200. For example, the flow rate limit management unit 22 decides not to execute flow control because the container 201 has a higher QoS and higher priority level set but to execute flow control with 10 Mpps as an upper limit because the container 202 has a lower QoS and lower priority level set and so on.

Although, according to this embodiment, the flow rate limit management unit 22 dynamically decides a receive flow rate limit value and executes the flow control, embodiments are not limited thereto. For example, in order to execute flow control, a predetermined value may be used as the receive flow rate limit value.

The smart NIC 10 includes the embedded switch 101 and a control unit 120, as illustrated in FIG. 1. The control unit 120 has the controller 102, an external communication reception unit 103, an internal communication reception unit 104, a transmission unit 105, and a re-transmission management unit 106. The control unit 120 further has the flow rewriting unit 107, a packet aggregation unit 108, a buffer management unit 109, a receive window (rwnd) management unit 110, an acknowledgement (ACK) management unit 111, a flow rate prediction unit 112, the mode determination unit 113, and the buffer 114.

The embedded switch 101 is hardware that performs packet transfer processing. The embedded switch 101 is coupled to an external apparatus 30 such as a computer in which other containers operate or the like. The embedded switch 101 is coupled to a container 200 that operates in the host computer 20.

The embedded switch 101 receives a packet transmitted from the external apparatus 30. The embedded switch 101 determines whether or not a flow rule with which processing for the received packet is registered exists in a cache included in the embedded switch 101.

When the flow rule with which processing for the received packet is registered does not exist in the cache, the embedded switch 101 inquires at the controller 102 about the flow rule with which processing for the received packet is registered. In response to the inquiry, the embedded switch 101 obtains the flow rule with which processing for the packet is registered from the controller 102 and stores it in the cache in the embedded switch 101. After that, the embedded switch 101 executes an action in a flow matching the flow rule with which processing for the received packet is registered and performs packet transfer processing.

On the other hand, when the flow rule with which processing for the received packet is registered exists in the cache, the embedded switch 101 executes an action in a flow matching the flow rule and performs the packet transfer processing.

For example, when the action in the flow matching the flow rule with which processing for the received packet is registered is to transfer the received packet to the container 201, the embedded switch 101 transfers the packet to the container 201. When the action in the flow matching the flow rule with which processing for the received packet is registered is to transfer the received packet to the controller 102, the embedded switch 101 transfers the packet to the controller 102.

When the flow control is performed, the embedded switch 101 receives, from the flow rewriting unit 107, a designation of a flow rule to be rewritten among flow rules stored in the cache and input of the flow rule to be newly rewritten and rewrites the flow rule. The flow rule when the flow control is performed has an indication that packets destined for the container 200 under the flow control are to be transferred to the buffer 114. The flow rule when the flow control is performed has an indication that communication data from the target container 200 of the flow control are to be transferred to the buffer 114. For example, communications to the target container 200 of the flow control including both of a communication to the container 200 and a communication from the container 200 are to be transferred to the buffer 114 once. Hereinafter, the target container 200 of the flow control will be called a “flow control target container”.

Between the embedded switch 101 and the container 200, a reception queue may be arranged. In that case, the transmission of packets from the embedded switch 101 to the container 200 is performed in the following manner. The embedded switch 101 stores a packet destined for a container 200, which is received from the transmission unit 105, in the reception queue. The container 200 obtains all of packets stored in the reception queue.

The controller 102 obtains and holds the flow rule to be used for communication with each of the containers 200 from the CNI plug-in 21. The controller 102 receives an inquiry about the flow rule from the embedded switch 101. The controller 102 outputs the flow rule according to the inquiry to the embedded switch 101.

The external communication reception unit 103 is a recipient in a case where the flow rule is changed by the flow rewriting unit 107 according to the flow control and the transfer destination of a communication to the flow control target container is changed to the smart NIC 10. When the flow control is performed and the flow rule is rewritten, the external communication reception unit 103 receives input of a packet destined for the flow control target container from the embedded switch 101. The external communication reception unit 103 outputs the obtained packet to the buffer management unit 109.

The internal communication reception unit 104 is a recipient in a case where the flow rule is changed by the flow rewriting unit 107 according to the flow control and the transfer destination of a communication from the flow control target container is changed to the smart NIC 10. When the flow control is performed and the flow rule is rewritten, the internal communication reception unit 104 receives, via the embedded switch 101, communication data transmitted from the flow control target container. The internal communication reception unit 104 outputs the received communication data to the buffer management unit 109. When the internal communication reception unit 104 receives an ACK from the flow control target container, the internal communication reception unit 104 outputs the received ACK to an ACK management unit 111.

When the flow control is performed and the flow rule is rewritten, the transmission unit 105 receives, from the buffer management unit 109, input of an aggregated packet destined for the flow control target container, which is generated by aggregating packets stored in the buffer 114 and destined for the flow control target container. The aggregation of packets destined for a plurality of flow control target containers will be described in detail later. The transmission unit 105 transmits the aggregated packet generated by aggregating packets and destined for the flow control target container to the destination flow control target container via the embedded switch 101. The transmission unit 105 outputs to the re-transmission management unit 106 a notification of the transmission of the aggregated packet destined for a low-delay container for low delay. After that, when the transmission unit 105 receives an instruction to re-transmit the aggregated packet from the re-transmission management unit 106, the transmission unit 105 re-transmits the aggregated packet to the destination flow control target container via the embedded switch 101.

When the flow control is performed and the flow rule is rewritten, the transmission unit 105 receives a communication from the flow control target container. The controller 102 communicates with the external apparatus 30 that is the destination of the communication via the embedded switch 101 in accordance with the received communication. For example, when the controller 102 receives an ACK including information on a rwnd from the transmission unit 105, the controller 102 transmits the ACK including information on the rwnd to the destination external apparatus 30 via the embedded switch 101.

The re-transmission management unit 106 detects a packet loss in conjunction with the ACK management unit 111 and instructs the transmission unit 105 to request re-transmission of the corresponding packet to the transmission source of the packet. For example, the re-transmission management unit 106 receives from the transmission unit 105 a notification of the transmission of the aggregated packet destined for a low-delay container that is the container 200. The re-transmission management unit 106 waits for reception of the ACKs for the transmitted aggregated packet for a predetermined waiting time that is determined in advance. When the re-transmission management unit 106 receives the notification of the reception of the ACKs from the ACK management unit 111 before the predetermined waiting time passes, the re-transmission management unit 106 instructs the buffer management unit 109 to release the aggregated packet.

On the other hand, when the predetermined waiting time has passed without receiving the notification of the reception of the ACKs, the re-transmission management unit 106 instructs the buffer management unit 109 to re-transmit the aggregated packet. The re-transmission management unit 106 instructs the ACK management unit 111 to transmit ACKs. By causing an ACK to be transmitted in this stage, the smart NIC 10 is ensured to be responsible for the re-transmission when the packet reaches up to the smart NIC 10 and the packet loss occurs between the smart NIC 10 and the host computer 20. Therefore, wasteful processing in which, although a packet reaches up to the smart NIC 10, the external apparatus 30 performs re-transmission of the packet may be omitted.

When flow control is started, the flow rewriting unit 107 receives, from the CNI plug-in, an instruction to transfer, to the smart NIC 10, packets destined for the flow control target container and to transfer, to the smart NIC 10, a communication from the flow control target container. In accordance with the instruction, the flow rewriting unit 107 notifies the embedded switch 101 of designation of a flow rule to be rewritten among flow rules and the flow rule to be newly rewritten and rewrites the flow rule.

For example, the flow rewriting unit 107 analyzes an action of the flow rule that the controller 102 has and identifies the flow rule destined for a port of the flow control target container. The flow rewriting unit 107 determines whether or not the identified flow rule exists in a cache included in the embedded switch 101. When the identified flow rule does not exist in the cache in the embedded switch 101, the flow rewriting unit 107 carries out the following processing on the flow rule that the controller 102 has. When the identified flow rule exists in the cache in the embedded switch 101, the flow rewriting unit 107 carries out the following processing on the flow rule stored in the cache in the embedded switch 101.

The flow rewriting unit 107 changes the flow rule for causing a packet destined for the port of the flow control target container to be destined for an internal port of the smart NIC 10, for example, to be transferred to the external communication reception unit 103. The flow rewriting unit 107 newly adds a flow rule that causes a packet from the flow control target container to be destined for the internal port of the smart NIC 10, for example, to be transferred to the internal communication reception unit 104. The flow rewriting unit 107 periodically performs the processing of adding the flow rule to the cache in the embedded switch 101 so that the flow rule does not drop from the cache.

A case may be considered where the coupling with the flow control target container is lost once during the flow control and is recovered. In this case, while the controller 102 receives input of a flow rule as usual from the CNI plug-in, the flow rewriting unit 107 receives, from the controller 102, an action corresponding to an inquiry about the flow rule. The flow rewriting unit 107 determines whether or not the corresponding action is to perform packet transmission destined for the flow control target container in the flow rule. When the corresponding action is to perform the packet transmission destined for the flow control target container in the flow rule, the flow rewriting unit 107 adds the flow rule described above to the cache in the embedded switch 101. In this case, through the controller 102, the flow rewriting unit 107 may perform addition of the flow rule to the cache in the embedded switch 101.

The packet aggregation unit 108 receives information on packets stored in the buffer 114 from the buffer management unit 109. The packet aggregation unit 108 decides packets to be aggregated based on the size of and inflow rate for the packets. The packet aggregation unit 108 transmits, to the buffer management unit 109, a request to obtain packets to be aggregated. After that, the packet aggregation unit 108 generates an aggregated packet by aggregating packets obtained from the buffer management unit 109. Next, the packet aggregation unit 108 instructs the buffer management unit 109 to store the generated aggregated packet to the buffer 114.

When the flow control is executed, the buffer management unit 109 stores, in the buffer 114, and manages packets destined for the flow control target container and packets from the flow control target container. For example, the buffer management unit 109 receives, from the external communication reception unit 103, input of packets destined for the flow control target container. The buffer management unit 109 stores, in the buffer 114, the obtained packets destined for the flow control target container.

The buffer management unit 109 notifies the packet aggregation unit 108 of information on packets for each flow control target container, which are stored in the buffer 114. The buffer management unit 109 receives designation of packets to be aggregated from the packet aggregation unit 108, obtains the designated packets from the buffer 114 and outputs them to the packet aggregation unit 108. After that, the buffer management unit 109 receives input of the aggregated packet from the packet aggregation unit 108. The buffer management unit 109 outputs the obtained aggregated packet to the transmission unit 105.

The buffer management unit 109 receives, via the internal communication reception unit 104, packets from the flow control target container. The obtained packets are stored to the buffer 114. After that, the buffer management unit 109 obtains and outputs to the transmission unit 105 the packets stored in the buffer 114.

The flow rate prediction unit 112 receives notification of execution of the flow control from the buffer management unit 109. The flow rate prediction unit 112 receives, from the buffer management unit 109, input of an inflow rate for packets for each flow control target container from the external apparatus 30 to the smart NIC 10 and a flow rate for the aggregated packet after packets are aggregated from the smart NIC 10 to the flow control target container. They are information targeting the packets obtained at the point in time. The inflow rate for packets for each flow control target container from the external apparatus 30 to the smart NIC 10 corresponds to an example of “first inflow rate”. The flow rate for an aggregated packet from the smart NIC 10 to the flow control target container corresponds to an example of “first flow rate”. After that, the flow rate prediction unit 112 executes the following processing for each flow control target container.

From the inflow rate and the flow rate after packets are aggregated, the flow rate prediction unit 112 calculates an aggregation ratio indicating a ratio between the inflow rate and the flow rate after packets are aggregated. For example, the flow rate prediction unit 112 calculates a ratio between the inflow rate of the last one flow and the flow rate after packets are aggregated as the aggregation ratio. Alternatively, the flow rate prediction unit 112 may apply an average of the aggregation ratio of the last N flows as the aggregation ratio.

Next, the flow rate prediction unit 112 uses the obtained information on the inflow rate to predict an inflow rate for packets to be transmitted next from the external apparatus 30 to the smart NIC 10. The inflow rate for packets to be transmitted from the external apparatus 30 to the smart NIC 10 corresponds to an example of “second inflow rate” and will be called a “predicted inflow rate” below. For example, the flow rate prediction unit 112 may use the inflow rate of the last flow directly as the predicted inflow rate or may use an average of inflow rates of the last N flows as the predicted inflow rate. After that, the flow rate prediction unit 112 notifies the calculated predicted inflow rate to the mode determination unit 113.

Next, the flow rate prediction unit 112 uses the predicted inflow rate and the aggregation ratio to calculate a predicted flow rate value that is a predicted value for the flow rate from the smart NIC 10 to the container 200 of an aggregated packet generated by aggregating received packets. This predicted flow rate value corresponds to an example of “second flow rate”. After that, the flow rate prediction unit 112 notifies the calculated predicted flow rate value to the mode determination unit 113.

For example, when the inflow rate of the last one flow is 20 Mpps and the inflow rate of the flow after packets are aggregated is 10 Mpps, the flow rate prediction unit 112 calculates the aggregation ratio as 50%. When the predicted inflow rate is 8 Mpps, the flow rate prediction unit 112 calculates the predicted flow rate value as 8×50%=4 Mpps.

The mode determination unit 113 receives notification of the predicted flow rate value from the flow rate prediction unit 112. The mode determination unit 113 receives input of information on the receive flow rate limit value from the flow rate limit management unit 22 in the host computer 20. The mode determination unit 113 determines whether the predicted flow rate value is less than or equal to the receive flow rate limit value or not. When the predicted flow rate value is less than or equal to the receive flow rate limit value, the mode determination unit 113 decides that the operation mode as the inflow rate increasing mode. The mode determination unit 113 notifies the inflow rate increasing mode as the operation mode to the buffer management unit 109, the rwnd management unit 110, and the ACK management unit 111. On the other hand, when the predicted flow rate value is greater than the receive flow rate limit value, the mode determination unit 113 decides the operation mode as an inflow rate reducing mode.

The inflow rate increasing mode is an operation mode in which a target inflow rate is calculated back based on the receive flow rate limit value and the aggregation ratio used for calculating the predicted flow rate value and the ACK timing and the receive window size are adjusted such that the inflow rate from the external apparatus 30 is increased to attain the target inflow rate. The inflow rate reducing mode is an operation mode in which a target inflow rate is similarly calculated and the ACK timing and rwnd are adjusted such that the inflow rate from the external apparatus 30 is reduced to attain the target inflow rate.

After that, the mode determination unit 113 notifies the decided operation mode to the rwnd management unit 110 and the ACK management unit 111. The mode determination unit 113 outputs, to the rwnd management unit 110, information on the receive flow rate limit value and the predicted flow rate value that is a flow rate for the next aggregated packet after packets are aggregated. The mode determination unit 113 obtains, from the flow rate prediction unit 112, the predicted inflow rate that is an inflow rate for the next packets before aggregated and outputs the predicted inflow rate along with the predicted flow rate value and the receive flow rate limit value to the ACK management unit 111.

The rwnd management unit 110 receives notification of the operation mode from the mode determination unit 113. The rwnd management unit 110 receives input of the receive flow rate limit value and the predicted flow rate value from the mode determination unit 113. The rwnd management unit 110 obtains the receive window size that is a size of the rwnd which is notified to the external apparatus 30 by the flow control target container. The receive window size is information indicating an amount of data that may be transmitted by one flow to the container 200. For example, the rwnd management unit 110 obtains, from the ACK management unit 111, the receive window size represented by the rwnd obtained by the ACK management unit 111 and stored in the ACK transmitted by the flow control target container. Hereinafter, the receive window size to be notified to the external apparatus 30 by the flow control target container will be called a “pre-adjustment receive window size”.

When the operation mode is the inflow rate increasing mode, the rwnd management unit 110 divides the receive flow rate limit value by the predicted flow rate value and thus calculates the ratio of the flow rate increase. Next, the rwnd management unit 110 adds an auxiliary size to a value acquired by multiplying the pre-adjustment receive window size by a value doubling the ratio of the flow rate increase and thus calculates a buffer size of the flow control target container. The rwnd management unit 110 reserves a buffer having the calculated buffer size as a buffer for the flow control target container. For example, when the predicted flow rate value is I′ and the receive flow rate limit value is M, the rwnd management unit 110 reserves a buffer having the buffer size calculated as the pre-adjustment receive window size×2M/I′+(auxiliary size) as the buffer for the flow control target container.

Since, as will be described below, a packet is released not at a time when the packet is transmitted to the flow control target container but at a time when the ACK is returned to the external apparatus 30 that is the transmission source of the packet, the double size of the size of the packet is preferably reserved. Accordingly, the pre-adjustment receive window size is multiplied by the value doubling the ratio of the flow rate increase. The auxiliary size is reserved to accommodate a case where the flow rate varies in the time-axis direction.

After that, the rwnd management unit 110 obtains, from the buffer management unit 109, information on the size of packets stored in the buffer for each flow control target container. Next, the rwnd management unit 110 calculates a free size in the buffer having the reserved buffer size for the flow control target container. The rwnd management unit 110 overwrites the value of the receive window size indicated by the rwnd stored in the ACK transmitted from the ACK management unit 111 to the transmission unit 105 with the calculated free size in the buffer for the flow control target container. In this way, the rwnd management unit 110 decides the receive window size based on the ratio of the flow rate increase. For example, the rwnd management unit 110 dynamically decides the receive window size from the receive flow rate limit value and the predicted flow rate value for aggregated packet. For example, in order to largely increase the flow rate limit when the predicted flow rate value is smaller than the receive flow rate limit value to some extent, the rwnd management unit 110 largely increases the receive window size. This may be considered for a case where many small packets exist or the like. When the predicted flow rate value is substantially equal to the receive flow rate limit value and the flow rate limit may not be greatly increased, the rwnd management unit 110 does not largely increase the receive window size.

On the other hand, when the operation mode is the inflow rate reducing mode, the rwnd management unit 110 divides the receive flow rate limit value by the predicted flow rate value and thus calculates the ratio of the flow rate reduction. The rwnd management unit 110 multiplies the pre-adjustment receive window size by a value doubling the ratio of the flow rate reduction and thus calculates a buffer size of the flow control target container. For example, when the predicted flow rate value is I′ and the receive flow rate limit value is M, the rwnd management unit 110 reserves, as the buffer for the flow control target container, a buffer having the size calculated as the pre-adjustment receive window size×2M/I′. Also in this case, the reason for the multiplication of the value doubling the ratio of the flow rate reduction is the same as the case in the inflow rate increasing mode. Because the flow rate is reduced, no auxiliary size may be reserved.

After that, the rwnd management unit 110 obtains, from the buffer management unit 109, information on the size of packets stored in the buffer for each flow control target container. Next, the rwnd management unit 110 calculates a free size in the buffer having the reserved buffer size for the flow control target container. The rwnd management unit 110 overwrites the receive window size in the rwnd stored in the ACK transmitted from the ACK management unit 111 to the transmission unit 105 with the calculated free size in the buffer for the flow control target container. In this way, the rwnd management unit 110 decides the receive window size based on the ratio of the flow rate reduction. For example, the rwnd management unit 110 dynamically decides the receive window size from the receive flow rate limit value and the predicted flow rate value for aggregated packet. For example, in order to largely reduce the flow rate limit when the predicted flow rate value is larger than the receive flow rate limit value to some extent, the rwnd management unit 110 largely reduces the receive window size. When the predicted flow rate value is substantially equal to the receive flow rate limit value and the flow rate limit may not be greatly reduced, the rwnd management unit 110 does not largely reduce the receive window size.

In this way, in both of the operation modes, the rwnd management unit 110 rewrites the rwnd before the packets are released. Although the ACK is returned after the ACK is transmitted from the flow control target container, the rwnd management unit 110 conceals that the reserved buffer size is the size calculated from the value doubling the ratio of the flow rate reduction by performing the rwnd rewiring before the release of the packet. The rwnd management unit 110 corresponds to an example of “window management unit”.

The ACK management unit 111 receives notification of the operation mode from the mode determination unit 113. The ACK management unit 111 receives, from the mode determination unit 113, input of the predicted inflow rate that is an inflow rate for the next packets before aggregated and the predicted flow rate value that is a flow rate for the aggregated packet after the next packets are aggregated. Next, the ACK management unit 111 calculates a predicted value for the next aggregation ratio. The ACK management unit 111 calculates a target inflow rate by dividing a receive inflow rate limit value by the predicted value for the next aggregation ratio.

For example, a relationship P=I/I′ is satisfied where I is the predicted inflow rate before packets are aggregated, I′ is the predicted flow rate value after the packets are aggregated, and P is the next aggregation ratio. A relationship L=M/P is satisfied where L is the target inflow rate in that case. When the operation mode is decided as the inflow rate increasing mode, a relationship I≤M≤I′ is satisfied, and, since P is less than or equal to 1, L is greater than or equal to M, and, since the target inflow rate is greater than or equal to the current receive inflow rate limit value, it may be seen that the inflow rate is to be increased. When the operation mode is decided as the inflow rate reducing mode, a relationship M≤I′≤I is satisfied, and, since P is greater than or equal to 1, L is less than or equal to M, and, since the target inflow rate is less than or equal to the current receive inflow rate limit value, it may be seen that the inflow rate is to be reduced.

After that, the ACK management unit 111 receives input of the ACK from the internal communication reception unit 104. The ACK management unit 111 executes the following processing in accordance with the operation mode and decides transmission timing for the ACK.

When the operation mode is the inflow rate increasing mode, the ACK management unit 111 returns ACKs collectively as much as possible by aiming at the target inflow rate. For example, when the target inflow rate is L, the ACK management unit 111 may increase the inflow rate and maintain the target inflow rate by outputting one ACK to the transmission unit 105 at 1/L (sec) and returning it to the external apparatus 30. However, when an ACK is returned every 1/L (sec), there is a risk that the amount of the ACK reception processing increases at the external apparatus 30 being the transmission source of packets and the performance of the transmission of the external apparatus 30 may decrease. Accordingly, in this embodiment, the ACK management unit 111 transmits ACKs collectively as much as possible by targeting at 1/L (sec) instead of every 1/L (sec). For example, the ACK management unit 111 outputs N ACKs collectively to the transmission unit 105 every N/L (sec). In this way, when the operation mode is the inflow rate increasing mode, the ACK management unit 111 decides the transmission timing for ACKs earlier since the inflow rate for packets increases and the number of ACKs to be returned thus increases.

On the other hand, when the operation mode is the inflow rate reducing mode, the ACK management unit 111 obtains an ACK and outputs, to the transmission unit 105, the ACK at a time after a delay added to the ACK outputting time by aiming at the target inflow rate. Thus, the ACK management unit 111 may reduce the inflow rate and maintain the target inflow rate. In this way, when the operation mode is the inflow rate reducing mode, the ACK management unit 111 decides the transmission timing for the ACKs later since the inflow rate for packets decreases and the number of ACKs to be returned thus decreases.

The ACK management unit 111 notifies reception of an ACK to the re-transmission management unit 106. When no ACK is received even after a lapse of a predetermined waiting time, the ACK management unit 111 receives an instruction to transmit an ACK from the re-transmission management unit 106. The ACK management unit 111 outputs an ACK to the transmission unit 105 and transmits the ACK to the external apparatus 30 that is the transmission source of the packet. Thus, the ACK management unit 111 may suppress wasteful re-transmission from the external apparatus 30 due to a packet loss within the smart NIC 10. The ACK management unit 111 notifies the rwnd stored in the ACK to the rwnd management unit 110.

Next, a flow of a packet and an ACK between the smart NIC 10 and the host computer 20 will be collectively described. A case will be described where containers 201 to 203 exist as the container 200 and the container 201 has a higher priority level while the containers 202 and 203 have lower priority levels.

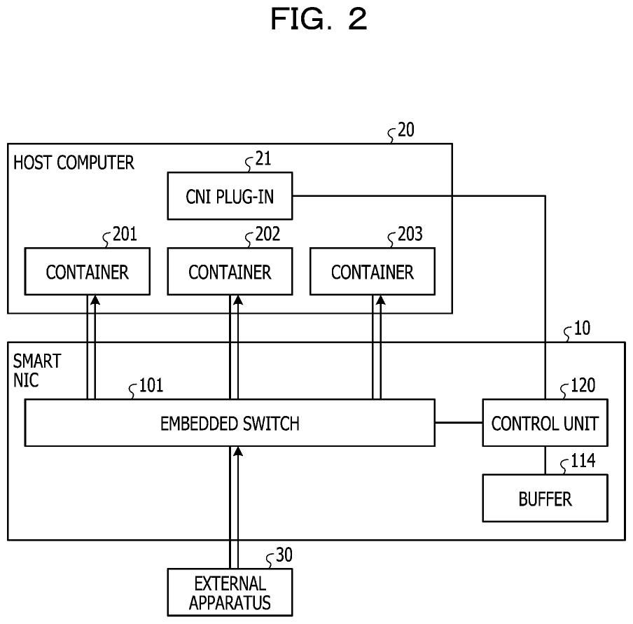

FIG. 2 illustrates a flow of a packet in a state where flow control has not started. As illustrated in FIG. 2, when flow control is not performed, packets transmitted from the external apparatus 30 are directly transferred to the containers 201 to 203 via the embedded switch 101.

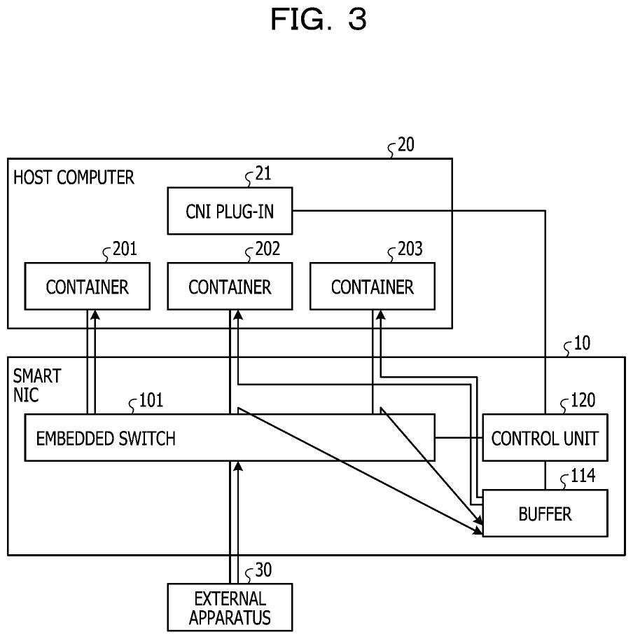

FIG. 3 illustrates a flow of a packet when flow control occurs. A case will be described where burst traffic occurs in the containers 202 and 203 having lower priority levels and flow control is started. In this case, the flow rule for transmission of packets destined for the containers 202 and 203 having lower priority levels is rewritten, and the destinations of the packets destined for the containers 202 and 203 are changed to the control unit 120 in the smart NIC 10. When the embedded switch 101 receives the packets destined for the containers 202 and 203, the embedded switch 101 transfers the received packets to the control unit 120. The control unit 120 stores, in the buffer 114, the packets destined for the containers 202 and 203. The control unit 120 transmits the packets from the buffer 114 to the containers 202 and 203 having lower priority levels at a flow rate that does not hinder communication with the container 201 having a higher priority level.

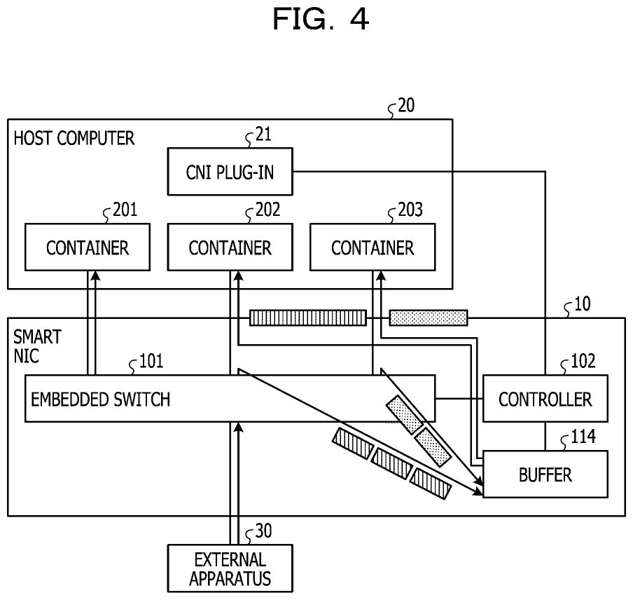

FIG. 4 illustrates a state of a packet when flow control occurs. When flow control is applied as in FIG. 3, the smart NIC 10 according to this embodiment actually aggregates packets and transfers the aggregated packets to the containers 202 and 203 as in FIG. 4. For example, the control unit 120 aggregates three packets destined for the container 202 into one aggregated packet and transmits the aggregated packet to the container 202. The control unit 120 aggregates two packets destined for the container 203 into one aggregated packet and transmits the aggregated packet to the container 203. Thus, three interrupts and three packet processes that have occurred for the container 202 may be reduced to one interrupt and one packet process. Two interrupts and two packet processes that have occurred for the container 203 may be reduced to one interrupt and one packet process. Therefore, the smart NIC 10 is able to reduce the CPU usage rate of the host computer 20 by the interrupt process while performing the flow control. The number of packet processes such as a TCP protocol process in the host computer 20 may also be reduced, and, also in this regard, the CPU usage rate may be reduced. From a viewpoint of the CPU usage rate by the network processes, the throughput may be improved even with the same CPU usage rate.

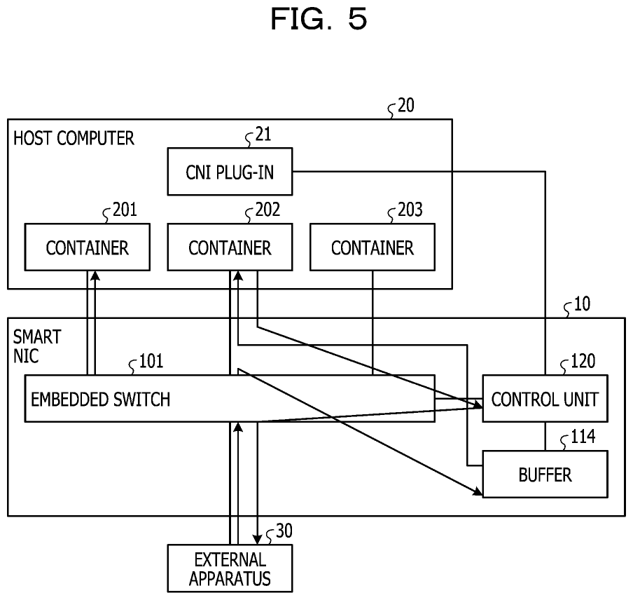

FIG. 5 illustrates a flow of an ACK when flow control occurs. When flow control occurs, the flow rule is rewritten also for communication from the containers 202 and 203 having lower priority levels and are transferred once to the control unit 120 in the smart NIC 10. The control unit 120 dynamically adjusts the timing for transmitting an ACK in accordance with the receive flow rate limit value, the predicted inflow rate that is an inflow rate for the next packets before aggregated, and the predicted flow rate value that is a flow rate for the aggregated packet after the next packets are aggregated. The control unit 120 decides the rwnd in accordance with the receive flow rate limit value as the flow rate limit value. The control unit 120 transmits ACKs to the external apparatus 30 that is the transmission source of the packets. When no response with ACKs is received within a predetermined waiting time from a time when the aggregated packet is transmitted to the container 202 or 203, the control unit 120 re-transmits the aggregated packet. The control unit 120 reduces the number of packet losses by releasing packets stored in the buffer 114 after the response with the ACKs is received.

For example, a case will be considered where the receive flow rate limit value for the container 202 is 10 Mpps and the receive flow rate limit value for the container 203 is 5 Mpps. Under this condition, processing to be performed by the control unit 120 will be described with respect to each of the following cases.

It is assumed that the inflow rate for packets destined for the container 202 is 15 Mpps, and the flow rate after the packets are aggregated is 8 Mpps and that the inflow rate for packets destined for the container 203 is 6 Mpps and the flow rate after the packets are aggregated is 3 Mpps. In this case, for both of the containers 202 and 203, the original inflow rates for packets exceed the receive flow rate limit values, but the flow rates after the packets are aggregated do not exceed the receive flow rate limit values. Accordingly, in this case, the mode determination unit 113 decides that the operation mode for both of the containers 202 and 203 is a flow rate increasing mode. For example, the control unit 120 controls so as to increase the amount of traffic such that the flow rate after packets are aggregated is 10 Mpps for the container 202 and increase the amount of traffic such that the flow rate after packets are aggregated is 5 Mpps for the container 203.

For example, it is assumed that, for the container 202, the flow rate prediction unit 112 predicts the predicted inflow rate that is the next inflow rate as 15 Mpps and predicts the predicted flow rate value that is the next flow rate after packets are aggregated is 8 Mpps by using the last inflow rate and the flow rate after packets are aggregated. In this case, the ACK management unit 111 calculates the aggregation ratio as 8/15. The ACK management unit 111 calculates the target inflow rate as 10/(8/15)=18.75 Mpps. Since the predicted inflow rate is 15 Mpps while the target inflow rate is 18.75, the amount of traffic is increased.

Accordingly, the ACK management unit 111 collectively transmits ACKs by targeting at 1/18.75 M (sec). In this case, the rwnd management unit 110 reserves the buffer size of the buffer in the container 202 based on pre-adjustment receive window size×2×(10/8)+auxiliary size=pre-adjustment receive window size×1.25+auxiliary size. The rwnd management unit 110 handles, as the rwnd, the free size of the buffer size of pre-adjustment receive window size×1.25+auxiliary size. Thus, the control unit 120 may increase the amount of traffic such that the flow rate after packets are aggregated is equal to 10 Mpps for the container 202.

It is assumed that the inflow rate for packets destined for the container 202 is 20 Mpps, and the flow rate after the packets are aggregated is 15 Mpps and that the inflow rate for packets destined for the container 203 is 10 Mpps and the flow rate after the packets are aggregated is 7 Mpps. In this case, for both of the containers 202 and 203, both of the original inflow rates for packets and the flow rates after packets are aggregated exceed the receive flow rate limit values. Accordingly, in this case, the mode determination unit 113 decides that the operation mode for both of the containers 202 and 203 is a flow rate reducing mode. For example, the control unit 120 controls so as to drop the amount of traffic such that the flow rate after packets are aggregated is 10 Mpps for the container 202 and drop the amount of traffic such that the flow rate after packets are aggregated is 5 Mpps for the container 203.

For example, it is assumed that, for the container 202, the flow rate prediction unit 112 predicts a predicted inflow rate that is the next inflow rate as 20 Mpps and predicts a predicted flow rate value that is the next flow rate after packets are aggregated is 15 Mpps by using the last inflow rate and flow rate after packets are aggregated. In this case, the ACK management unit 111 calculates the aggregation ratio as 15/20. The ACK management unit 111 calculates the target inflow rate as 10/(15/20)=13.33 Mpps. Since the predicted inflow rate is 20 Mpps while the target inflow rate is 13.33, the amount of traffic is dropped.

Accordingly, the ACK management unit 111 transmits ACKs by targeting at 13.33 Mpps and adding a delay. In this case, the rwnd management unit 110 reserves the buffer size of the buffer in the container 202 based on pre-adjustment receive window size×2×(10/15)=pre-adjustment receive window size×1.33. The rwnd management unit 110 handles, as the rwnd, the free size of the buffer size of pre-adjustment receive window size×1.33. Thus, the control unit 120 may drop the amount of traffic such that the flow rate after packets are aggregated is equal to 10 Mpps for the container 202.

By implementing the control by the control unit 120 by utilizing software, for example, implementation of complicated processing in conjunction with the host computer 20 is facilitated in a case where the flow control is performed by using the smart NIC 10. In a case where the control by the control unit 120 is implemented by utilizing software, a more abundant memory space may be reserved than an application-specific integrated circuit (ASIC)- or field-programmable gate array (FPGA)-based NIC. Thus, the size of the buffer 114 may be increased, and many packets may be aggregated to one. In order to more effectively make use of that advantage, the rwnd management unit 110 adjusts the receive window size to be increased as much as possible in consideration of a state that packets are aggregated. When packets as many as possible are retained in the buffer by the rwnd management unit 110, subsequent transmission of data by the external apparatus 30 being the transmission source is difficult unless ACKs are returned. Accordingly, the ACK management unit 111 returns ACKs for the packets the reception of which is completed in the smart NIC 10 to the external apparatus 30 so that the retention of the communication is resolved.

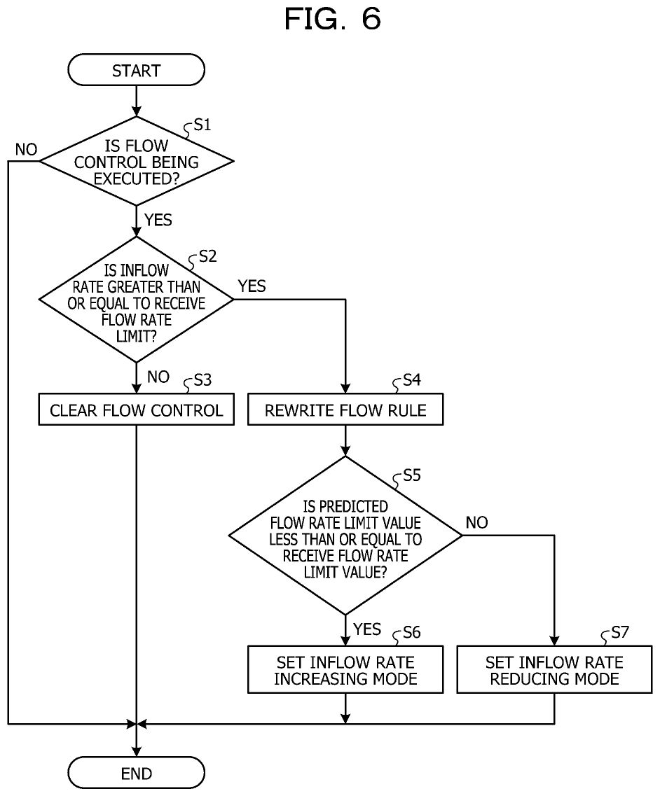

FIG. 6 is a flowchart of flow rate limit control processing. Next, with reference to FIG. 6, a flow of flow rate limit control processing by the smart NIC according to this embodiment will be described. Flow control for a certain container 200 as a target will be described as an example.

The flow rate limit management unit 22 in the host computer 20 determines whether the flow control is being executed or not (step S1). When the flow control is not being executed (negative in step S1), the flow rate limit control processing ends.

On the other hand, when the flow control is being executed (positive in step S1), the flow rate limit management unit 22 determines whether the inflow rate is greater than or equal to the receive flow rate limit value or not (step S2).

When the inflow rate is less than the receive flow rate limit value (negative in step S2), the flow rate limit management unit 22 notifies the flow rewriting unit 107 of cancellation of the flow control for the certain container 200. The flow rewriting unit 107 in response to the notification of the cancellation of the flow control rewrites the flow rule for the flow control over the certain container 200 to the regular flow rule for transmission of packets destined for the certain container 200 and clears the flow control (step S3).

On the other hand, when the inflow rate is greater than or equal to the receive flow rate limit value (positive in step S2), the flow rate limit management unit 22 notifies the flow rewriting unit 107 of the flow control over the certain container 200. The flow rewriting unit 107 in response to the notification of the flow control rewrites the flow rule stored in the cache in the embedded switch 101 such that packets destined for the certain container 200 are transferred to the control unit 120 in the smart NIC 10 (step S4).

Next, from the inflow rate and the flow rate after packets are aggregated, the flow rate prediction unit 112 calculates an aggregation ratio. The flow rate prediction unit 112 predicts an inflow rate to the smart NIC 10 for the next packets and acquires a predicted inflow rate. From the predicted inflow rate and the aggregation ratio, the flow rate prediction unit 112 calculates a predicted flow rate value that is a predicted value of the flow rate for an aggregated packet after the next packets are aggregated. After that, the mode determination unit 113 determines whether the predicted flow rate value is less than or equal to the receive flow rate limit value or not (step S5).

When the predicted flow rate value is less than or equal to the receive flow rate limit value (positive in step S5), the mode determination unit 113 determines, as the operation mode, the inflow rate increasing mode in which control is performed such that the flow rate after packets are aggregated reaches the receive flow rate limit value. The mode determination unit 113 transmits a notification that the inflow rate increasing mode is determined as the operation mode to the rwnd management unit 110 and the ACK management unit 111 and sets the inflow rate increasing mode (step S6).

On the other hand, when the predicted flow rate value is greater than the receive flow rate limit value (negative in step S5), the mode determination unit 113 determines, as the operation mode, the inflow rate reducing mode in which control is performed such that the flow rate after packets are aggregated are reduced to the receive flow rate limit value. The mode determination unit 113 transmits a notification that the inflow rate reducing mode is determined as the operation mode to the rwnd management unit 110 and the ACK management unit 111 and sets the inflow rate reducing mode (step S7).

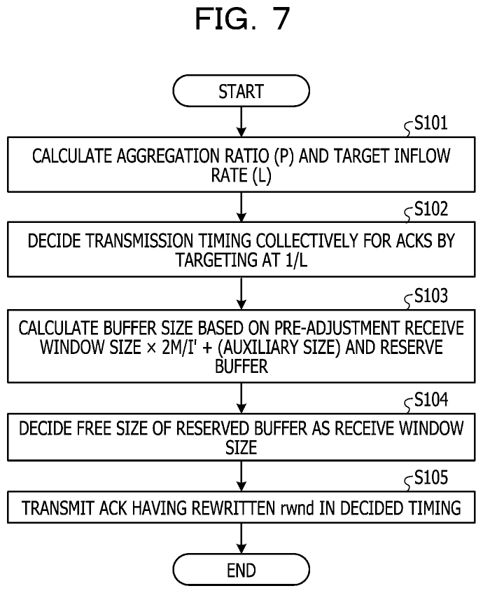

FIG. 7 is a flowchart of processing of deciding ACK timing and a receive window size in the inflow rate increasing mode. Next, with reference to FIG. 7, a flow of processing of deciding ACK timing and a receive window size in the inflow rate increasing mode will be described. It is assumed that the predicted inflow rate that is an inflow rate for the next packets before aggregated is I, the predicted flow rate value that is a flow rate for the aggregated packet after the next packets are aggregated is I′, the receive flow rate limit value is M, the aggregation ratio is P, and the target inflow rate is L.

The ACK management unit 111 calculates the aggregation ratio for the next flow as P=I/I′. Next, the ACK management unit 111 calculates the target inflow rate as L=M/P (step S101).

Next, the ACK management unit 111 decides the transmission timing collectively for ACKs by targeting at 1/L (sec) (step S102).

The rwnd management unit 110 calculates the buffer size based on pre-adjustment receive window size×2M/I′+(auxiliary size). The rwnd management unit 110 reserves a buffer having the calculated buffer size (step S103).

After that, the rwnd management unit 110 acquires the free size in the reserved buffer and decides it as the receive window size (step S104).

After that, the ACK management unit 111 outputs ACKs to the transmission unit 105 in the decided timing. The rwnd management unit 110 rewrites the rwnd for the ACKs transmitted to the transmission unit 105 with the decided receive window size. By transmitting the ACKs to the external apparatus 30 via the embedded switch 101, the transmission unit 105 transmits the ACKs having the rewritten rwnd to the external apparatus 30 in the timing decided by the ACK management unit 111 (step S105).

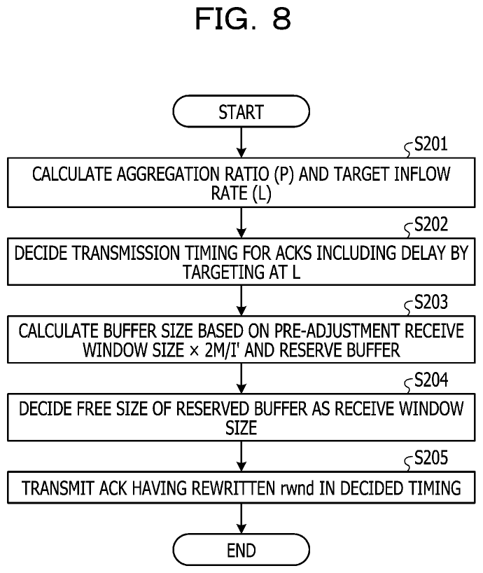

FIG. 8 is a flowchart of processing of deciding ACK timing and a receive window size in the inflow rate reducing mode. Next, with reference to FIG. 8, a flow of processing of deciding ACK timing and a receive window size in the inflow rate reducing mode will be described. It is assumed again that the predicted inflow rate before the next packets are aggregated is I, the predicted flow rate value after the next packets are aggregated is I′, the receive flow rate limit value is M, the aggregation ratio is P, and the target inflow rate is L.

The ACK management unit 111 calculates the aggregation ratio for the next flow as P=I/I′. Next, the ACK management unit 111 calculates the target inflow rate as L=M/P (step S201).

Next, the ACK management unit 111 decides the transmission timing for ACKs including a delay by targeting at L (Mpps) (step S202).

The rwnd management unit 110 calculates the buffer size based on pre-adjustment receive window size×2M/I′. The rwnd management unit 110 reserves a buffer having the calculated buffer size (step S203).

After that, the rwnd management unit 110 acquires the free size in the reserved buffer and decides it as the receive window size (step S204).

After that, the ACK management unit 111 outputs ACKs to the transmission unit 105 in the decided timing. The rwnd management unit 110 rewrites the rwnd for the ACKs transmitted to the transmission unit 105 with the decided receive window size. By transmitting the ACKs to the external apparatus 30 via the embedded switch 101, the transmission unit 105 transmits the ACKs having the rewritten rwnd to the external apparatus 30 in the timing decided by the ACK management unit 111 (step S205).

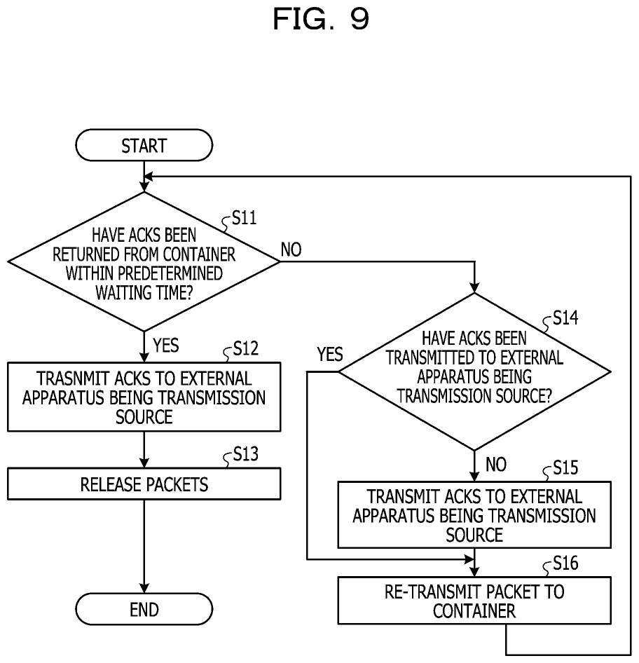

FIG. 9 is a flowchart of ACK transmission processing. Next, with reference to FIG. 9, a flow of ACK transmission processing for addressing a packet loss will be described.

The re-transmission management unit 106 receives notification of the transmission of the aggregated packet from the buffer management unit 109. In accordance with notification of acquisition of ACKs from the ACK management unit 111, the re-transmission management unit 106 determines whether or not the ACKs have been returned from the flow control target container within a predetermined waiting time (step S11).

When the ACKs have been returned from the flow control target container within the predetermined waiting time (positive in step S11), the re-transmission management unit 106 transmits the ACKs to the external apparatus 30 being the transmission source of the packets via the embedded switch 101 (step S12).

After that, the buffer management unit 109 is instructed to release the packets. The buffer management unit 109 deletes the packets from the buffer 114 and releases the packets (step S13).

On the other hand, when the ACKs have not been returned from the flow control target container within the predetermined waiting time (negative in step S11), the re-transmission management unit 106 determines whether or not the ACKs have been transmitted to the external apparatus 30 being the transmission source of the packets (step S14). When the ACKs have been transmitted (positive in step S14), the ACK transmission processing proceeds to step S16.

On the other hand, when the ACKs have not been transmitted to the external apparatus 30 being the transmission source of the packets (negative in step S14), the re-transmission management unit 106 instructs the ACK management unit 111 to transmit the ACKs. In response to the instruction, the ACK management unit 111 transmits the ACKs to the external apparatus 30 being the transmission source of the packets (step S15).

The re-transmission management unit 106 instructs the buffer management unit 109 to re-transmit the packets to the flow control target container. In response to the instruction, the buffer management unit 109 re-transmits the aggregated packet for which the ACKs have not reached to the flow control target container (step S16). After that, the ACK transmission processing returns to step S11.

As described above, the smart NIC according to this embodiment stores packets destined for the flow control target container in the buffer during the flow control over containers, generates an aggregated packet by aggregating the packets, and transfers the aggregated packet to the flow control target container. The smart NIC according to this embodiment calculates a target flow rate value by using the next predicted inflow rate and the predicted flow rate value and receive flow rate limit value after packets are aggregated next time and adjusts the transmission timing for the ACKs so as to reach the target flow rate value. The smart NIC according to this embodiment calculates a buffer size to be reserved by using the predicted flow rate value and receive flow rate limit value after packets are aggregated next time and decides the receive window size from the free size in the reserved buffer.

Thus, by aggregating packets, the number of interrupts and the number of packet processes may be suppressed so that the CPU usage rate per unit communication amount may be reduced. By deciding the ACK transmission timing and the receive window size based on the aggregation ratio, the following effects may be acquired. For example, in a case where many smaller packets exist although the inflow rate from the external apparatus 30 is high and the effect of the aggregation of the packets is high, the inflow rate may be increased to enhance the throughput even under the inflow limit. Conversely, in a case where packets are large and the effect of the aggregation of the packets is low, the inflow rate is reduced to the flow rate limit so that the amount of transfer may be optimized.

When ACKs are not responded within a predetermined waiting time after the packets are transmitted to the host computer, the smart NIC according to this embodiment transmits the ACKs to an external apparatus being the transmission source of the packets and re-transmits the packets to the host computer. This may compensate for the reachability of the packets between the smart NIC and the host computer, increase the speed of the re-transmission processing, and reduce the number of wasteful re-transmissions by the external apparatus being the packet transmission source.

Having described the container 200 as an example in the description above, the smart NIC functioning as an interface for communication in an arithmetic processing device may exhibit the same functionality and effects even in another arithmetic processing device.

(Hardware Configuration)

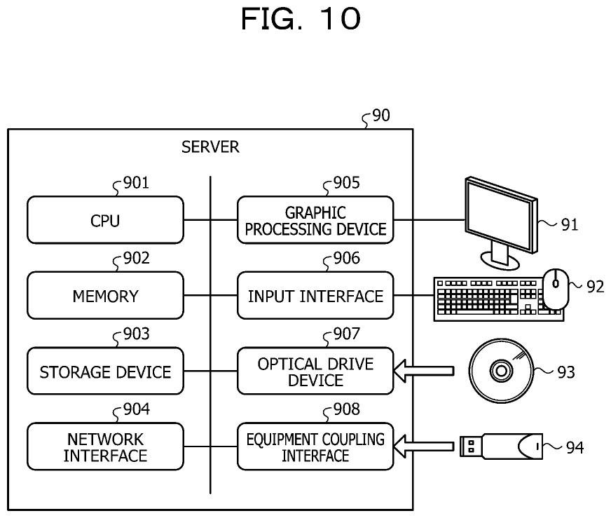

FIG. 10 illustrates a hardware configuration of a server. The host computer 20 and smart NIC 10 illustrated in FIG. 1 may be implemented by a server 90 illustrated in FIG. 10.

The server 90 includes, as illustrated in FIG. 10, a CPU 901, a memory 902, a storage device 903, a network interface 904, a graphic processing device 905, an input interface 906, an optical drive device 907, and an equipment coupling interface 908. The CPU 901 is coupled, via a bus, to the memory 902, the storage device 903, the network interface 904, the graphic processing device 905, the input interface 906, the optical drive device 907, and the equipment coupling interface 908.

A display device 91 such as a monitor or the like, for example, is coupled to the graphic processing device 905. An input device 92 such as a keyboard and a mouse, for example, is coupled to the input interface 906. An operator of the server 90 performs input of information to the server 90 by using the display device 91 and the input device 92.

The memory 902 includes a read-only memory (ROM) and a random-access memory (RAM). The ROM stores a boot program such as a Basic Input/Output System (BIOS) or the like, for example.

A portable storage medium 93 such as a magnetic disk, an optical disk or the like, for example, is removably attached to the optical drive device 907. The optical drive device 907 writes and reads data to and from the portable storage medium 93 inserted thereto. A Universal Serial Bus (USB) memory 94 or the like is removably attached to the equipment coupling interface 908. The storage device 903 is a hard disk, a solid-state drive (SSD), or the like.

The CPU 901 reads various programs from the storage device 903, loads the programs to the memory 902, and executes the programs. Thus, the CPU 901 implements functions of the container 200, the CNI plug-in 21, and the flow rate limit management unit 22 exemplarily illustrated in FIG. 1.

Without limiting to cases where the programs are stored in the storage device 903, the programs may be stored in a removable storage medium and may be read by the CPU 901 through the optical drive device 907 or the like, for example. Alternatively, the programs may be stored in another computer coupled to the server 90 over a network (such as a local area network (LAN), a wide area network (WAN) or the like). The programs may be read from the other computer via the network interface 904 by the CPU 901.

The network interface 904 is the smart NIC 10. The network interface 904 has a processor and a memory formed with an FPGA, for example. The memory in the network interface 904 stores various programs including a program that implements the function of the control unit 120 exemplarily illustrated in FIG. 1. The memory in the network interface 904 implements the function of the buffer 114.

The processor in the network interface 904 reads and executes various programs from the memory so as to implement the functions of the control unit 120 exemplarily illustrated in FIG. 1.

### Embodiment 2

Next, Embodiment 2 will be described. According to Embodiment 1, control over the flow rate limit is performed with reference to the rate that is the number of packets per second. Since a band is acquired by multiplying the rate by an average packet size, it may be said that the control according to Embodiment 1 is substantially band-based control. However, a latency other than the band is also an important index for a network. For example, edge computing has been widely spread in which processing is performed in an edge server close to an end point, instead of a cloud over a network. In such edge computing, improvement in latency more than band has been demanded.

In a system in which a plurality of containers operates including a container to have a higher priority level and to have a lower delay, a situation may be considered in which burst traffic occurs in the container having a higher priority level. When a packet reaches in such a condition, the container unconditionally performs reception processing thereon, but the CPU is used by the reception processing. When the CPU is used by the packet reception processing, which is processing by the entire system, the CPU usage rate of the processing on the container having a higher priority level decreases correspondingly.

Accordingly, for example, a technology has been proposed in which, when the smart NIC is not used, CPU allocation and a flow rate limit are dynamically controlled based on the flow rate of the network in consideration of the CPU usage rate of the network processing. However, this technology does not consider a system including the smart NIC. A method may be considered that suppresses a decrease of the CPU usage rate of the processing on a container having a higher priority level by simply increasing the number of host computers. However, the increased number of host computers increases TCO. Reduction of TCO has been greatly demanded, and simply increasing the number of hosts is not practical.

When the smart NIC is not used, a packet that is not received by a container because of flow control is discarded in the NIC. Since the discarded packet is re-transmitted, the network performance significantly decreases. Against this, this may be avoided by aggregating packets in the manner described according to Embodiment 1 by using the smart NIC. However, under the flow control using the smart NIC, even when a packet reaches the smart NIC, the corresponding container does not recognize the arrival of the packet to the smart NIC, which causes waiting for reception between data pieces and may possibly deteriorate the latency.

When the rate of the flow control is R (pps), it may be said that packets are transmitted to the host every 1/R. For example, roughly, 1/R may be considered as an overhead of the latency due to the flow control. However, even when the packet is retained in the smart NIC, the overhead of the latency due to the flow control is not recognized by the container if the packet is delivered to the container before the container uses the received data. Accordingly, a problem arises when a packet is not delivered to the container until the container uses the received data even though the packet is retained in the smart NIC.

Since the flow control is performed independently of the amount of data used for the processing on a container, it may be considered that the processing is terminated in a state that the container is waiting for data reception. When the processing stops in the data reception waiting state, CPU allocation is not performed for the container, which may possibly deteriorate the delay.

Accordingly, in the information processing system according to this embodiment, the smart NIC stores, in a reception queue, more packets than the flow rate limit. The container normally retrieves packets under the flow rate limit from the reception queue and, immediately before the data reception waiting, the container retrieves packets greater than or equal to the flow rate limit from the reception queue. Hereinafter, the information processing system according to this embodiment will be described. In the following description, the description for the operations of the same components same as those of Embodiment 1 will be omitted.

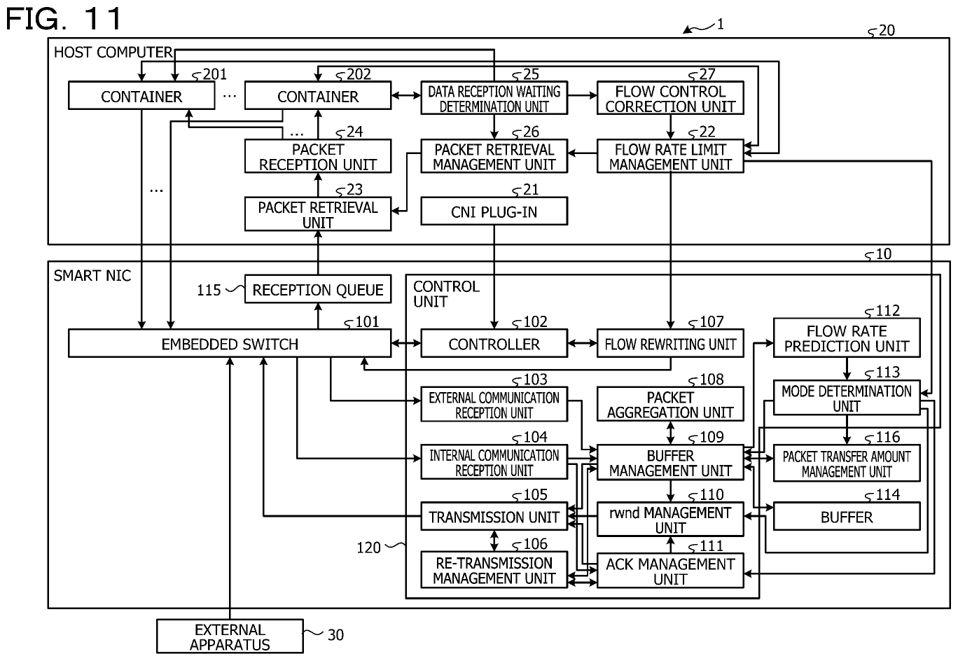

FIG. 11 is a block diagram illustrating an information processing system according to Embodiment 2. The smart NIC 10 according to this embodiment has a reception queue 115 and a packet transfer amount management unit 116, in addition to the components of Embodiment 1.

The reception queue 115 is a storage unit that temporarily stores a packet when the packet is transmitted from the embedded switch 101 to the container 200. Although one reception queue 115 is illustrated in FIG. 11, a plurality of reception queues 115 may be provided.

The mode determination unit 113 holds, for each of containers 200, information on whether or not it is a low-delay container that is the container 200 preferably having a low delay. When the flow control is executed, the mode determination unit 113 determines whether the flow control target container that is the target container 200 of the flow control is a low-delay container or not. When the flow control target container is a low-delay container, the mode determination unit 113 decides that the packet transfer mode for the flow control target container is a low delay mode. On the other hand, when the flow control target container is not a low-delay container, the mode determination unit 113 decides that the packet transfer mode for the flow control target container is a normal mode. The mode determination unit 113 notifies the decided packet transfer mode to the packet transfer amount management unit 116. After that, the mode determination unit 113 determines whether the operation mode is the inflow rate reducing mode or the flow rate increasing mode. After that, when the flow control is cancelled, the packet transfer mode is automatically reset.

The packet transfer amount management unit 116 manages the packet amount to be stored in the reception queue 115. When the flow control is started, the packet transfer amount management unit 116 receives notification of the packet transfer mode from the mode determination unit 113.

When the packet transfer mode is the normal mode, the packet transfer amount management unit 116 instructs the buffer management unit 109 to send out packets equivalent to the amount depending on the receive flow rate limit value. On the other hand, when the packet transfer mode is the low delay mode, the packet transfer amount management unit 116 instructs the buffer management unit 109 to send out more packets than the amount depending on the receive flow rate limit value. The more packets than the amount depending on the receive flow rate limit value may be greater than or equal to the amount for packets to be used for the reception processing in the container 200 in which data reception waiting occurs due to no reception of packets for the amount to be used for the reception processing. For example, more packets than the amount depending on the receive flow rate limit value may be packets for the amount 1.5 times of the packet amount depending on the receive flow rate limit value.

Next, the host computer 20 will be described. The host computer 20 according to this embodiment has a packet retrieval unit 23, a packet reception unit 24, a data reception waiting determination unit 25, a packet retrieval management unit 26, and a flow control correction unit 27, in addition to the components of Embodiment 1.

The packet retrieval unit 23 executes processing of retrieving a packet from the reception queue 115 and outputting the packet to the packet reception unit 24. The packet retrieval unit 23 receives an instruction regarding the amount for retrieving packets from the packet retrieval management unit 26. According to this embodiment, as the amount for retrieving packets, there are two kinds of retrieval of all packets and retrieval of packets equivalent to the receive flow rate limit value.

When retrieval of all packets is instructed, the packet retrieval unit 23 retrieves all of packets stored in the reception queue 115. When retrieval of packets equivalent to the receive flow rate limit value is instructed, the packet retrieval unit 23 retrieves packets for an amount depending on the instructed receive flow rate limit value from the reception queue 115. The packet retrieval unit 23 outputs the retrieved packets to the packet reception unit 24.

When data reception waiting occurs in a low-delay container and when the receive flow rate limit value for the low-delay container is increased such that packets for an amount to be used for the reception processing flows into the low-delay container, the packet retrieval unit 23 performs the following processing. The packet retrieval unit 23 retrieves, from the reception queue 115, the remaining packets for the amount depending on the new receive flow rate limit value in addition to the already retrieved packets. After that, the packet retrieval unit 23 repeats the retrieval of packets in accordance with the new receive flow rate limit value. The packet retrieval unit 23 outputs the retrieved packets to the packet reception unit 24.

The packet reception unit 24 obtains all of the packets retrieved from the reception queue 115 by the packet retrieval unit 23. The packet reception unit 24 performs processing such as packet analysis or the like and outputs the packet to the packet destination container 200.

The data reception waiting determination unit 25 holds, for each of containers 200, information on whether or not it is a low-delay container. The data reception waiting determination unit 25 determines whether or not the container 200 that is a flow control target container and is a low-delay container will wait for data reception after start of the flow control. For example, the data reception waiting determination unit 25 obtains the amount for packets to be used for the reception processing by the flow control target container and compares the amount to the amount for packets depending on the receive flow rate limit value. When the amount for packets to be used for the reception processing by the flow control target container is greater than the amount for packets depending on the receive flow rate limit value, the data reception waiting determination unit 25 determines that the flow control target container will wait for data reception. When determining that the flow control target container will wait for data reception, the data reception waiting determination unit 25 notifies the packet retrieval management unit 26 and the flow control correction unit 27 of that the flow control target container will wait for data reception and of information on the amount for packets to be used for the reception processing.

The packet retrieval management unit 26 holds, for each of the containers 200, information on whether or not it is a low-delay container. When the flow control is started, the packet retrieval management unit 26 obtains the receive flow rate limit value for the flow control target container from the flow rate limit management unit 22.

When the flow control target container is a low-delay container, the packet retrieval management unit 26 instructs the packet retrieval unit 23 to retrieve packets for an amount depending on the receive flow rate limit value. After that, when receiving the notification of the data reception waiting regarding the flow control target container and the low-delay container from the data reception waiting determination unit 25, the packet retrieval management unit 26 obtains the new receive flow rate limit value for the container 200 from the flow rate limit management unit 22. The new receive flow rate limit value is a value corresponding to the flow rate for the amount for packets to be used for the reception processing that will wait for data reception in the container 200 in which data reception waiting occurs. After that, the packet retrieval management unit 26 instructs the packet retrieval unit 23 to retrieve packets for the amount depending on the new receive flow rate limit value.

On the other hand, when the flow control target container is a low-delay container, the packet retrieval management unit 26 instructs the packet retrieval unit 23 to retrieve all of the packets.

When the data reception waiting determination unit 25 determines that data reception waiting occurs in the flow control target container and the low-delay container, the flow control correction unit 27 receives, from the data reception waiting determination unit 25, the notification that the flow control target container will wait for data reception along with the information on the amount for packets to be used for the reception processing which will wait for data reception. The flow control correction unit 27 performs correction on the flow rate for each container 200.

For example, the flow control correction unit 27 sets the flow rate for the low-delay container which will wait for data reception as the amount for packets to be used for the reception processing which will wait for data reception. Next, the flow control correction unit 27 selects a container 200 for which the flow rate may be suppressed. For example, the flow control correction unit 27 extracts containers 200 that are not low-delay containers from the flow control target containers. Next, the flow control correction unit 27 selects the container 200 that operates in the flow rate increasing mode from the extracted containers 200. The container 200 that operates in the flow rate increasing mode has a state that the flow rate after packets are aggregated is lower than the flow rate limit value. Thus, even by reducing the flow rate limit value for the container 200, no effect occurs in the performance of the container 200.

When no container 200 that operates in the flow rate increasing mode exists among the containers 200 that are not low-delay containers, the flow control correction unit 27 selects, from the low-delay containers, a container 200 for which no flow rate correction is performed for a predetermined period of time. It may be considered that for the low-delay containers for which flow control correction is not performed, the flow rate limit may be reduced closely to the flow rate at that time.

After that, the flow control correction unit 27 calculates a reduced flow rate for the selected container 200 in accordance with an increase in flow rate for the container 200 which is determined to wait for data reception and for which the flow rate is increased to the amount for packets to be used for the reception processing. The flow control correction unit 27 calculates the receive flow rate limit value for each of the containers 200 in accordance with the decided flow rate and corrects the flow rate limit. The flow control correction unit 27 notifies the flow rate limit management unit 22 of the receive flow rate limit value for each of the containers 200 under the corrected flow rate limit. Hereinafter, the correction of the flow rate limit by the flow control correction unit 27 will be called a “dynamic flow rate adjustment”.

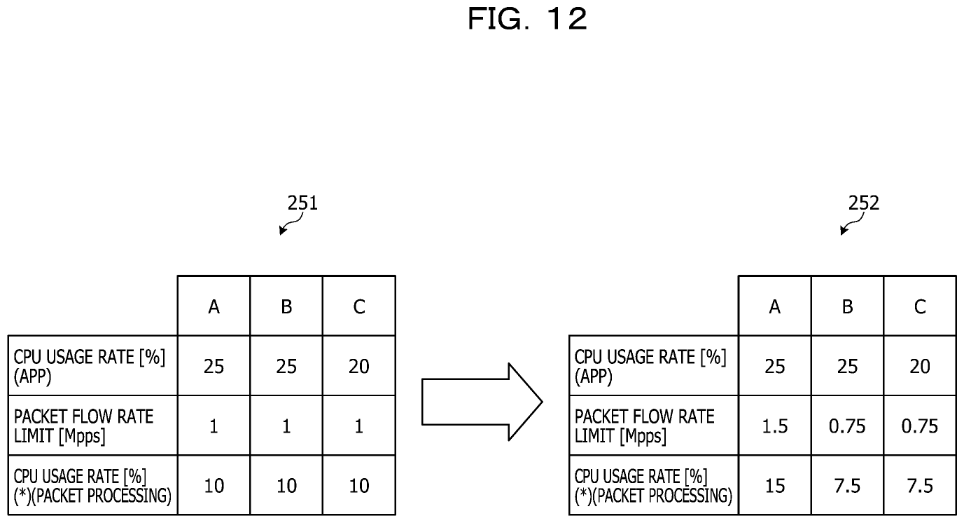

FIG. 12 illustrates an example of the dynamic flow rate adjustment. For example, a case where containers A to C exist as the flow control target containers will be described. The container A is a low-delay container on which latency reduction processing is performed when data reception waiting occurs. Table 251 is a table illustrating a state of each of the containers A to C on which latency reduction processing is performed, and Table 252 is a table illustrating a state of each of the containers A to C after the latency reduction processing is performed.

Before the latency reduction processing is performed, as illustrated on Table 251, flow control of 1 (Mpps) is carried out on all of the containers A to C, and their CPU usage rates by the packet processing are 10%. For simplicity of description, it is assumed that the CPU is consumed 10% by the packet processing for 1 (Mpps).

When the latency reduction processing is carried out on the container A and by changing the receive flow rate limit value such that packets for the amount to be used for the reception processing on the container A are retrieved, the receive flow rate limit value for the container A changes to 1.5 (Mpps). Accordingly, the flow control correction unit 27 selects the containers B and C having a CPU usage rate as low as 10% by the packet processing from the flow control target containers that operate in the flow rate increasing mode. The receive flow rate limit value is corrected so as to reduce the flow rate for the containers B and C in accordance with the increased flow rate for the container A. Thus, as illustrated on Table 252, both of the receive flow rate limit values for the containers B and C change to 0.75 (Mpps). In this case, the CPU usage rate by the packet processing on the containers B and C is 7.5, which is still a low value as the usage rate and allows for the packet processing to be carried out on the containers B and C.

According to Embodiment 1, the flow rate from a user is increased to the receive flow rate limit value for a container 200 operating in the flow rate increasing mode. On the other hand, the flow control correction unit 27 according to this embodiment reduces an increase in flow rate for a container 200 with allowance among the containers 200 operating in the inflow rate increasing mode as much as possible and uses the decrease in inflow rate to increase the flow rate for a low-delay container for which data reception waiting occurs.

The flow rate limit management unit 22 receives notification of the correction of the flow rate limit from the flow control correction unit 27. The flow rate limit management unit 22 corrects the receive flow rate limit value for each of the containers 200 in accordance with the notified correction.

In performing the latency reduction processing, it may be configured that packets for the amount to be used for the reception processing are obtained when the data reception waiting occurs and packets for the amount defined by the flow control are normally obtained. In this case, the flow control correction unit 27 may be omitted. In this case, the packet retrieval management unit 26 causes the packet retrieval unit 23 to retrieve, from the reception queue 115, packets in accordance with the packet amount to be used for the reception processing which will wait for data reception.

However, when the packet retrieval is performed immediately before data reception waiting, there is a risk that the processing delay affects the container 200. Accordingly, in this embodiment, the flow control over the container 200 is alleviated for the container 200 when the latency reduction processing is performed, and the effect of the data reception waiting is reduced so that the processing delay may be concealed from the container 200.

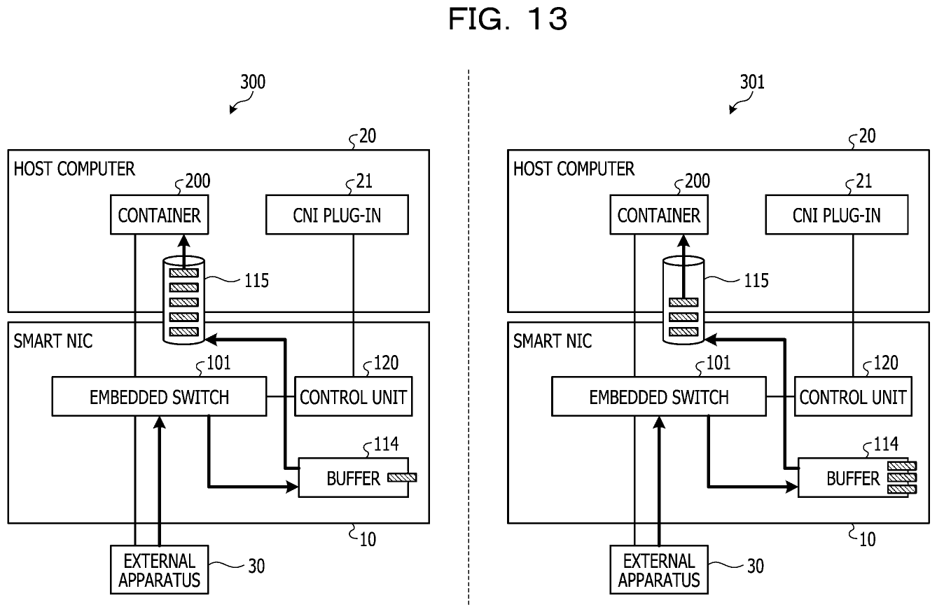

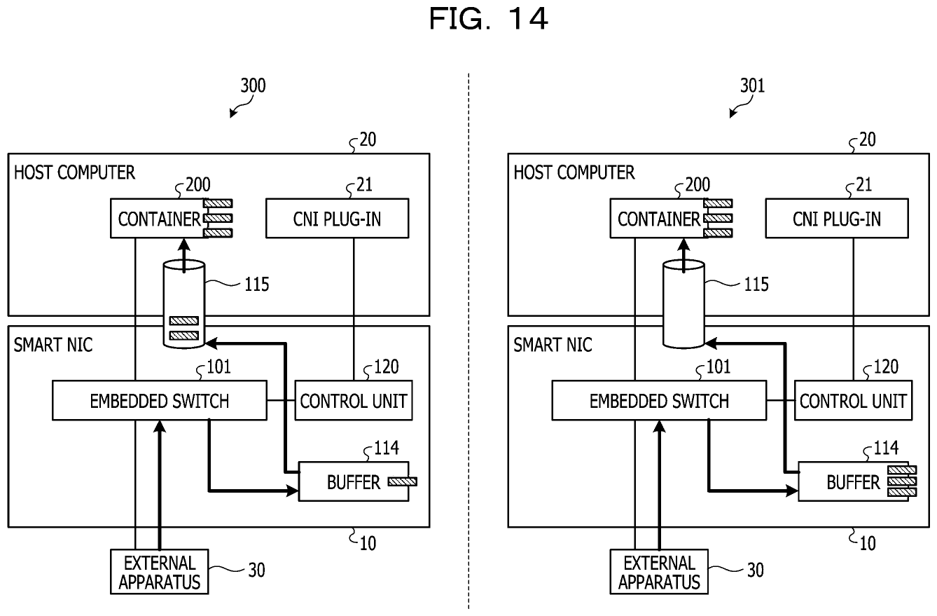

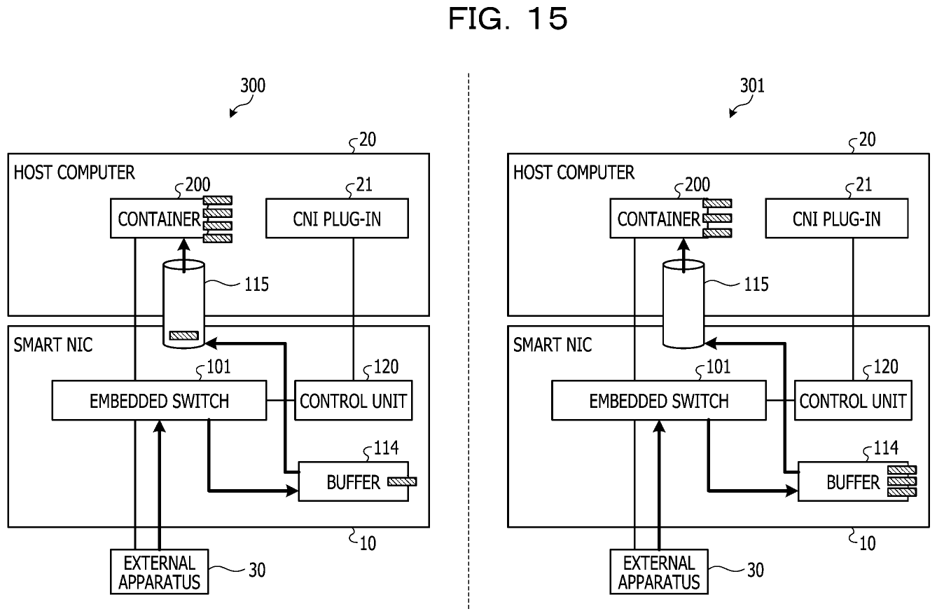

FIG. 13 is a first diagram illustrating a comparison between a case where latency reduction processing is performed and a case where the processing is not performed. FIG. 14 a second diagram illustrating a comparison between a case where latency reduction processing is performed and a case where the processing is not performed. FIG. 15 is a third diagram illustrating a comparison between a case where latency reduction processing is performed and a case where the processing is not performed. The latency reduction processing is processing for storing packets for a predetermined amount greater than or equal to the amount depending on the receive flow rate limit in the reception queue 115 when flow control is performed and adjusting the amount for packets to be retrieved on the host computer 20 side.

Next, with reference to FIGS. 13 to 15, a comparison between a case where latency reduction processing is performed and a case where the processing is not performed will be described. An information processing system 300 in FIGS. 13 to 15 represents the information processing system 1 in a case where latency reduction processing is performed, and an information processing system 301 represents the information processing system 1 in a case where the latency reduction processing is not performed. A case where the amount defined by the flow control is an amount for three packets will be described.

As illustrated in FIG. 13, in execution of the flow control, when the latency reduction processing is performed, the control unit 120 stores, in the reception queue 115, packets for a predetermined amount greater than the amount defined by the flow control. For example, in a case where packets for an amount 1.5 times as the predetermined amount are transmitted, the control unit 120 retrieves five packets from the buffer 114 and stores them in the reception queue 115 as illustrated in the information processing system 300. On the other hand, in a case where the latency reduction processing is not performed, the control unit 120 stores, in the reception queue 115, packets for the amount defined by the flow control. For example, as illustrated in the information processing system 301, the control unit 120 retrieves three packets for the amount defined by the flow control from the buffer 114 and stores them in the reception queue 115.

Next, with reference to FIG. 14, a case will be described in which the container 200 performs reception processing on packets for an amount under the flow rate limit from the state in FIG. 13. The following description assumes a case where the container 200 performs reception processing on three packets as an example. When latency reduction processing is performed, the host computer 20 limits the amount for packets to be retrieved from the reception queue 115 to the amount depending on the receive flow rate limit value. In this case, as illustrated in the information processing system 300, the container 200 obtains three packets from five packets stored in the reception queue 115 and performs reception processing thereon. On the other hand, when latency reduction processing is not performed, the host computer 20 retrieves all packets stored in the reception queue 115. In this case, as illustrated in the information processing system 301, the container 200 obtains all of three packets stored in the reception queue 115 and performs reception processing thereon. In this way, in both of the cases where latency reduction processing is performed and the case where latency reduction processing is not performed when the container 200 performs reception processing on packets for an amount under the flow rate limit, the container 200 may complete the reception processing immediately.

Next, with reference to FIG. 15, a case will be described in which the container 200 performs reception processing on packets for an amount greater than or equal to the flow rate limit from the state in FIG. 13. The following description assumes a case where the container 200 performs reception processing on four packets as an example. In a case where latency reduction processing is performed, when the container 200 will wait for data reception, the host computer 20 retrieves packets for an amount depending on the receive flow rate limit value corresponding to the amount for packets to be used in the reception processing from the packets stored in the reception queue 115. In this case, as illustrated in the information processing system 300, the container 200 obtains four packets stored in the reception queue 115 and performs reception processing thereon. Thus, the information processing system 300 may perform the reception processing on the four packets that the information processing system 300 has attempted to execute. On the other hand, when latency reduction processing is not performed, the host computer 20 retrieves all packets stored in the reception queue 115. Also in this case, as illustrated in the information processing system 301, the container 200 obtains all of three packets stored in the reception queue 115 and performs reception processing thereon. For example, since one packet is lacking for performing the reception processing on the four packets by the container 200, the reception processing is not completed, and data reception waiting occurs. In this way, in a case where latency reduction processing is performed when the container 200 performs reception processing on packets for an amount greater than the receive flow rate limit value, the container 200 may avoid the data reception waiting and continue the processing. Therefore, by performing the latency reduction processing, the container 200 may reduce the waiting time.

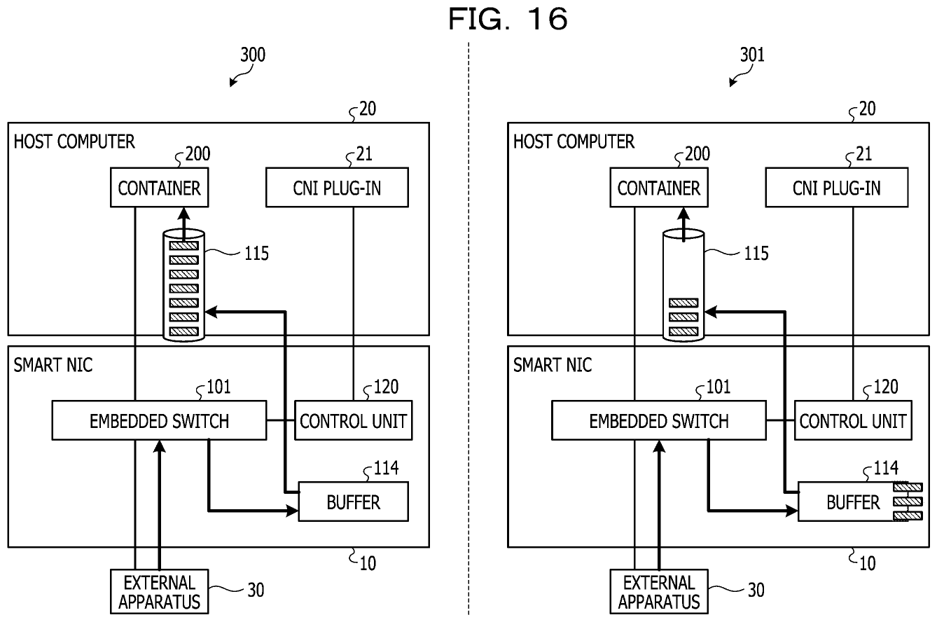

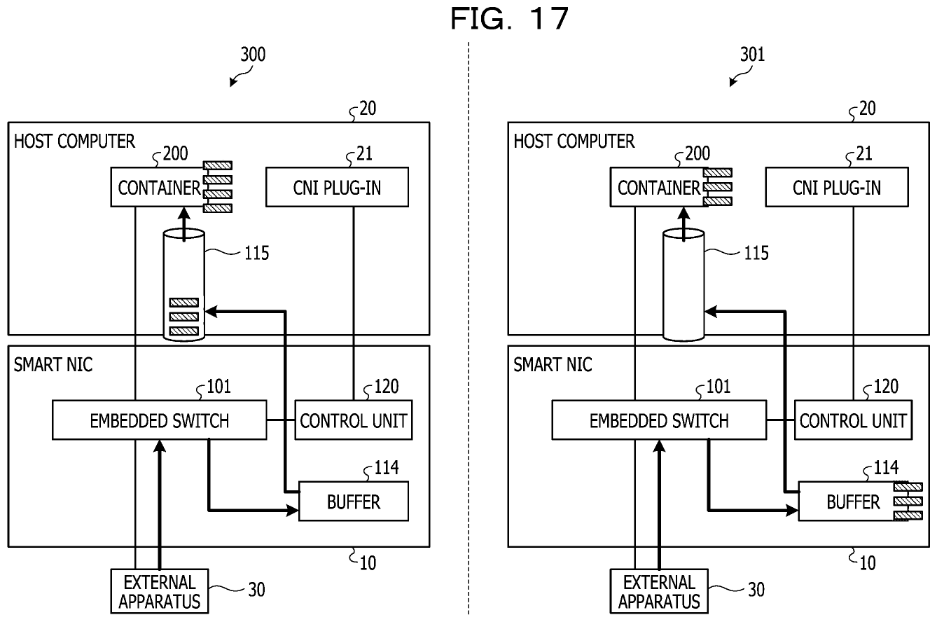

FIG. 16 is a first diagram illustrating a comparison between a case where dynamic flow rate adjustment is performed and a case where the adjustment is not performed. FIG. 17 is a second diagram illustrating a comparison between a case where dynamic flow rate adjustment is performed and a case where the adjustment is not performed. Next, with reference to FIGS. 16 and 17, a comparison between a case where dynamic flow rate adjustment is performed and a case where the adjustment is not performed will be described. The information processing system 300 in FIGS. 16 and 17 represents the information processing system 1 in a case where the latency reduction processing is performed and dynamic flow control is performed. The information processing system 301 represents the information processing system 1 in a case where the latency reduction processing is not performed and dynamic flow control is not performed either.

For example, a case will be described where, in a state where the amount defined by the flow control is equivalent to three packets, a low-delay container requests reception processing on four packets and the flow control is alleviated to the amount equivalent to four packets accordingly.

As illustrated in the information processing system 300 in FIG. 16, in a case where the amount depending on the alleviated receive flow rate limit value is four packets, the control unit 120 in a low-delay container in which latency reduction processing is performed stores six packets 1.5 times of the four packets in the reception queue 115. On the other hand, in a case where latency reduction processing is not performed and dynamic flow rate adjustment is not performed, the control unit 120 stores three packets in the reception queue 115 even after a low-delay container requests reception processing on four packets, as illustrated in the information processing system 301.

After that, as illustrated in FIG. 17, when the container 200 continues the reception processing on four packets and in a case where dynamic flow control is performed, the container 200 may obtain four packets to be used from the reception queue 115 to which six packets have been transmitted. Thus, the container 200 may immediately perform and complete the reception processing on the packets. On the other hand, in a case where dynamic flow control is not performed, the container 200 may retrieve three packets from the reception queue 115 but waits for the remaining one packet to be stored in the reception queue 115 in accordance with the flow control over the amount equivalent to three packets. Therefore, in the state that the reception processing has not completed, the container 200 waits for data. In this way, by performing the dynamic flow control, the container 200 may reduce the waiting time more.

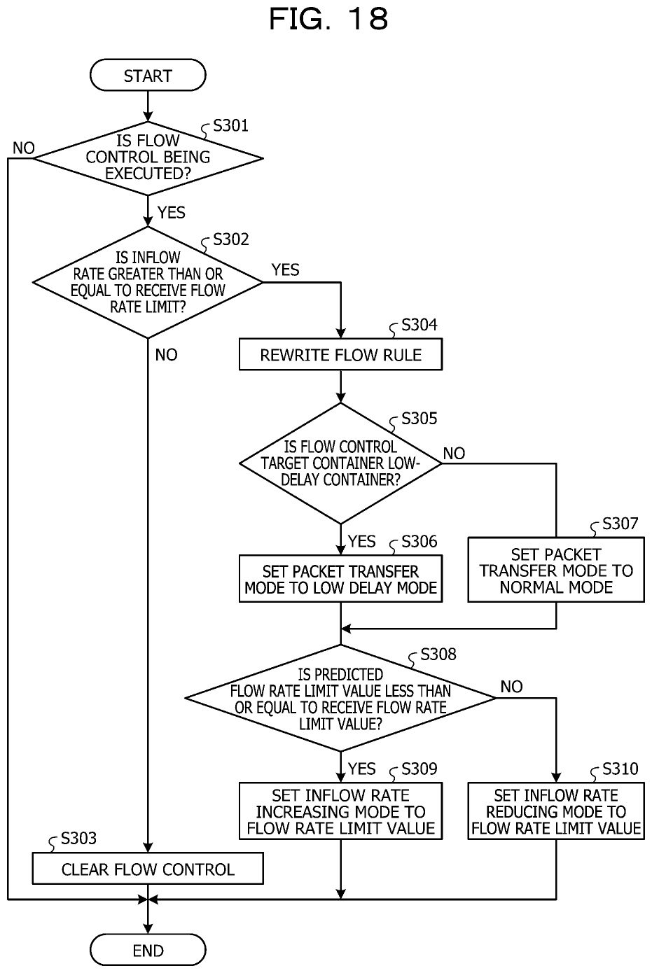

FIG. 18 is a flowchart of flow rate limit control processing to which latency reduction processing is added. Next, with reference to FIG. 18, a flow of flow rate limit control processing to which the latency reduction processing is added.

The flow rate limit management unit 22 in the host computer 20 determines whether the flow control is being executed or not (step S301). When the flow control is not being executed (negative in step S301), the flow rate limit control processing ends.

On the other hand, when the flow control is being executed (positive in step S301), the flow rate limit management unit 22 determines whether the inflow rate is greater than or equal to the receive flow rate limit or not (step S302).

When the inflow rate is less than the receive flow rate limit (negative in step S302), the flow rate limit management unit 22 notifies the flow rewriting unit 107 of cancellation of the flow control over the certain container 200. The flow rewriting unit 107 in response to the notification of the cancellation of the flow control rewrites the flow rule for the flow control over the certain container 200 to the regular flow rule for transmission of packets destined for the certain container 200 and clears the flow control (step S303).

On the other hand, when the inflow rate is greater than or equal to the receive flow rate limit (positive in step S302), the flow rate limit management unit 22 notifies the flow rewriting unit 107 of the flow control over the certain container 200. The flow rewriting unit 107 in response to the notification of the flow control rewrites the flow rule stored in the cache in the embedded switch 101 such that packets destined for the certain container 200 are transferred to the control unit 120 in the smart NIC 10 (step S304).

Next, from the inflow rate and the flow rate after packets are aggregated, the flow rate prediction unit 112 calculates an aggregation ratio. The flow rate prediction unit 112 predicts an inflow rate to the smart NIC 10 for the next packets and acquires a predicted inflow rate. From the predicted inflow rate and the aggregation ratio, the flow rate prediction unit 112 calculates a predicted flow rate value that is a predicted value of the flow rate for an aggregated packet after the next packets are aggregated. The flow rate prediction unit 112 notifies the mode determination unit 113 of the predicted flow rate value and instructs to select a mode. The mode determination unit 113 determines whether the flow control target container that is the target container 200 being a target of the flow control is a low-delay container or not (step S305).

When the flow control target container is a low-delay container (positive in step S305), the mode determination unit 113 decides the packet transfer mode as a low delay mode and notifies it to the packet transfer amount management unit 116. The packet transfer amount management unit 116 instructs the buffer management unit 109 to transmit packets for a predetermined amount greater than or equal to the amount depending on the receive flow rate limit value and sets the packet transfer mode to the low delay mode (step S306).

On the other hand, when the flow control target container is not a low-delay container (negative in step S305), the mode determination unit 113 decides the packet transfer mode as a normal mode and notifies it to the packet transfer amount management unit 116. The packet transfer amount management unit 116 instructs the buffer management unit 109 to transmit packets for the amount defined by the flow control and sets the packet transfer mode to the normal mode (step S307).

Next, the mode determination unit 113 determines whether the predicted flow rate value is less than or equal to the receive flow rate limit value or not (step S308).

When the predicted flow rate value is less than or equal to the receive flow rate limit value (positive in step S308), the mode determination unit 113 determines, as the operation mode, the inflow rate increasing mode in which control is performed such that the flow rate after packets are aggregated reaches the receive flow rate limit value. The mode determination unit 113 transmits a notification that the inflow rate increasing mode is determined as the operation mode to the rwnd management unit 110 and the ACK management unit 111 and sets the inflow rate increasing mode (step S309).

On the other hand, when the predicted flow rate value is greater than the receive flow rate limit value (negative in step S308), the mode determination unit 113 determines, as the operation mode, the inflow rate reducing mode in which control is performed such that the flow rate after packets are aggregated are reduced to the receive flow rate limit value. The mode determination unit 113 transmits a notification that the inflow rate reducing mode is determined as the operation mode to the rwnd management unit 110 and the ACK management unit 111 and sets the inflow rate reducing mode (step S310).

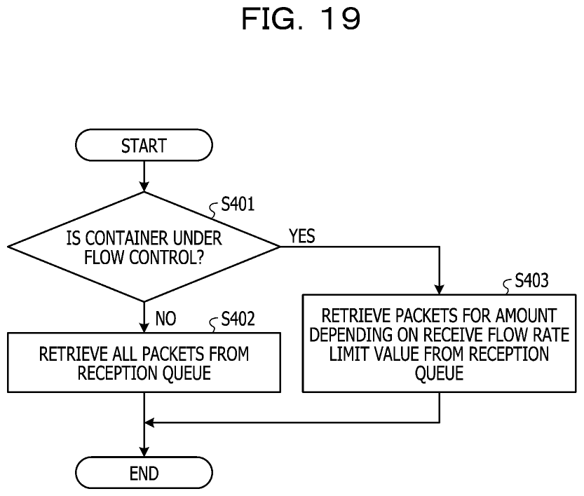

FIG. 19 is a flowchart of packet retrieval processing. Next, with reference to FIG. 19, a flow of packet retrieval processing by the host computer 20 will be described. The following description assumes a case where a container 200 is a low-delay container.

The packet retrieval management unit 26 determines whether the container 200 is under the flow control (step S401).

When the container 200 being a low-delay container is not under the flow control (negative in step S401), the packet retrieval management unit 26 instructs the packet retrieval unit 23 to retrieve all of the packets. The packet retrieval unit 23 in response to the instruction from the packet retrieval management unit 26 retrieves all packets from the reception queue 115 (step S402).

On the other hand, when the container 200 being a low-delay container is under the flow control (positive in step S401), the packet retrieval management unit 26 instructs the packet retrieval unit 23 to retrieve packets for an amount depending on the receive flow rate limit value. The packet retrieval unit 23 receives the instruction from the packet retrieval management unit 26 and retrieves packets for the amount depending on the receive flow rate limit value from the reception queue 115 (step S403).

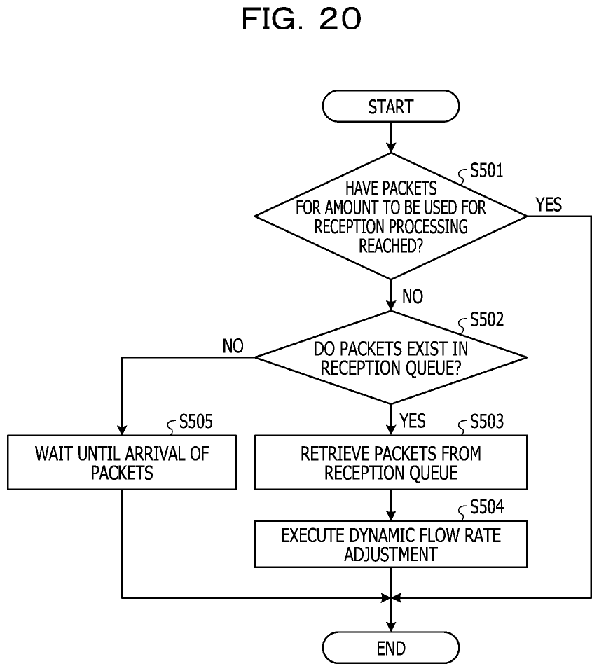

FIG. 20 is a flowchart of processing to be performed when packets are received by a container. Next, with reference to FIG. 20, a flow of processing upon reception of packets by a container 200 being a low-delay container will be described.

The data reception waiting determination unit 25 determines whether or not packets to be used for reception processing have reached (step S501). When packets to be used for reception processing have already reached (positive in step S501), the processing upon packet reception ends.

On the other hand, when the packets to be used for reception processing have not reached (negative in step S501), the data reception waiting determination unit 25 determines that the container 200 will have a data reception waiting state. The data reception waiting determination unit 25 instructs the packet retrieval unit 23 to obtain packets for an amount to be used for the reception processing. The packet retrieval unit 23 determines whether packets exist in the reception queue 115 or not (step S502). When packets exist therein (positive in step S502), the packet retrieval unit 23 retrieves, from the reception queue 115, the remaining packets of the packets for the amount to be used for the reception processing (step S503).

After that, the flow control correction unit 27 executes the dynamic flow control such that the flow rate of the container 200 is increased to the amount for packets to be used for the reception processing (step S504).

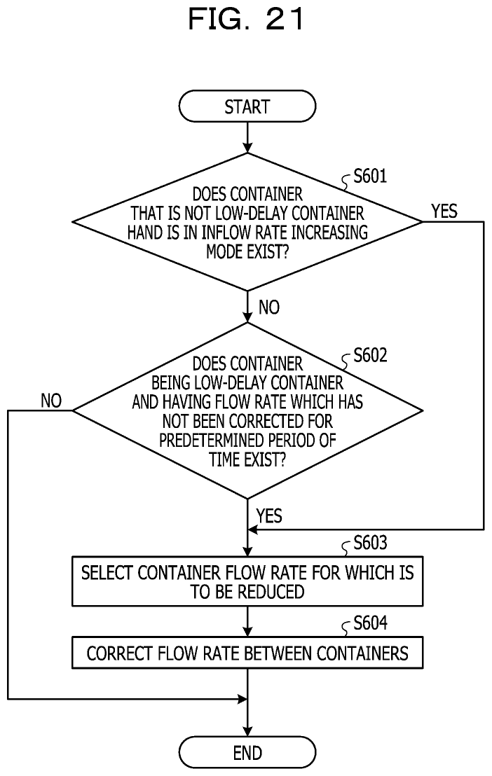

FIG. 21 is a flowchart of the dynamic flow rate adjustment processing. FIG. 21 corresponds to an example of the processing to be executed in step S504 in FIG. 20. Next, a flow of the dynamic flow rate adjustment processing will be described with reference to FIG. 21.

The flow control correction unit 27 determines whether a container 200 that is not a low-delay container and is in the flow rate increasing mode exists or not (step S601). When the container 200 that is not a low-delay container and is in the flow rate increasing mode exists (positive in step S601), the flow control correction unit 27 moves to step S603.

On the other hand, when the container 200 that is not a low-delay container and is in the flow rate increasing mode does not exist (negative in step S601), the flow control correction unit 27 determines whether a container 200 being a low-delay container and having a flow rate which has not been corrected for a predetermined period of time exists or not (step S602). When the container 200 being a low-delay container and having the flow rate which has not been corrected for the predetermined period of time does not exist (negative in step S602), the flow control correction unit 27 ends the flow rate limit correction processing.

On the other hand, when the container 200 being a low-delay container and having a flow rate which has not been corrected for the predetermined period of time exists (positive in step S602), the flow control correction unit 27 moves to step S603.

After that, the flow control correction unit 27 selects a container the flow rate for which is to be reduced from the container 200 that is not a low-delay container and is in the flow rate increasing mode or the container 200 that is a low-delay container and the flow rate for which has not been corrected for the predetermined period of time (step S603).

After that, the flow control correction unit 27 corrects the flow rate between the containers 200 (step S604). The flow control correction unit 27 notifies the corrected flow rate for each of the containers 200 to the flow rate limit management unit 22. The flow rate limit management unit 22 decides a receive flow rate limit value for each of the containers 200 in accordance with the notified flow rate for each of the containers 200 and changes the flow control over each of the containers 200.

As described above, when the flow control target container is a low-delay container, the smart NIC according to this embodiment stores, in the reception queue, packets for a predetermined amount greater than or equal to the amount depending on the receive flow rate limit value. To the low-delay container under the flow control, the packets for the amount depending on the receive flow rate limit value are normally retrieved from the reception queue 115 and are passed. Thus, the information processing system according to this embodiment achieves the flow control. When data reception waiting occurs in a low-delay container under the flow control, packets for an amount to be used for reception processing, which will wait for data reception, are retrieved from the reception queue and are passed to the container. Thus, the information processing system according to this embodiment avoids data waiting of a low-delay container and enhances the latency. The information processing system increases the flow rate for the container which will wait for data reception up to the amount for packets to be used for reception processing and reduces the flow rate for another container with allowance to perform dynamic flow rate correction which adjusts the flow rates between containers. This may ensure that occurrence of data waiting by the low-delay container is suppressed, and the latency of the low-delay container may be enhanced.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a memory; and
a processor coupled to the memory, the processor being configured to perform processing including:
executing a buffer management processing that, under flow control over communication executed by an arithmetic processing device, sequentially obtains a plurality of packets transmitted and destined for the arithmetic processing device, stores the packets in a buffer, generates one aggregated packet by aggregating the packets, and transmits the aggregated packet to the arithmetic processing device;
executing an ACK management processing that decides transmission timing for ACKs to a transmission source of the packets based on a flow rate for the aggregated packet; and
executing a window management processing that decides a receive window size representing a data amount to be transmitted by one flow to the arithmetic processing device based on the flow rate for the aggregated packet.

2. The information processing apparatus according to claim 1, the processing further comprising:
executing a mode determination processing that
predicts, based on a first inflow rate that is an inflow rate to the information processing apparatus of existing packets that have already been obtained, a second inflow rate for next packets to be transmitted next,
predicts a second flow rate for the aggregated packet generated by aggregating the next packets based on a ratio of the first inflow rate and a first flow rate that is a flow rate to the arithmetic processing device for the aggregated packet generated by aggregating the existing packets and the second inflow rate, and
decides whether an inflow rate for packets destined for the arithmetic processing device is to be increased or be reduced based on the second flow rate and a receive flow rate limit value used in the flow control,
wherein the ACK management processing is configured to
decide the transmission timing earlier when the inflow rate for packets destined for the arithmetic processing device is to be increased, and
decide the transmission timing later when the inflow rate for packets destined for the arithmetic processing device is to be reduced, and
the window management processing is configured to
increase the receive window size when the inflow rate for packets destined for the arithmetic processing device is to be increased, and
reduce the receive window size when the inflow rate for packets destined for the arithmetic processing device is to be reduced.

3. The information processing apparatus according to claim 2, wherein the ACK management processing is configured to decide the transmission timing based on the second inflow rate, the second flow rate, and the receive flow rate limit value.

4. The information processing apparatus according to claim 2, wherein the window management processing is configured to decide the receive window size based on the second flow rate and the receive flow rate limit value.

5. The information processing apparatus according to claim 1, wherein the ACK management processing is configured to
obtain ACKs for the packets transmitted from the arithmetic processing device, and
transmit the ACKs in the decided transmission timing.

6. The information processing apparatus according to claim 5, the processing further comprising:
executing a re-transmission management processing that, when ACKs are not transmitted from the arithmetic processing device within a predetermined waiting time from a time when the aggregated packet is transmitted to the arithmetic processing device by the buffer management unit, causes the buffer management processing to re-transmit the aggregated packet and causes the ACK management processing to transmit the ACKs.

7. A computer-implemented information processing method comprising:
under flow control over communication executed by an arithmetic processing device,
sequentially obtaining a plurality of packets transmitted and destined for the arithmetic processing device,
storing the packets in a buffer,
generating one aggregated packet by aggregating the packets, and
transmitting the aggregated packet to the arithmetic processing device;
deciding transmission timing for ACKs to a transmission source of the packets based on a flow rate for the aggregated packet; and
deciding a receive window size representing a data amount to be transmitted by one flow to the arithmetic processing device based on the flow rate for the aggregated packet.

8. A non-transitory computer-readable storage medium storing an information processing program for causing a computer to perform processing comprising:
under flow control over communication executed by an arithmetic processing device,
sequentially obtaining a plurality of packets transmitted and destined for the arithmetic processing device,
storing the packets in a buffer,
generating one aggregated packet by aggregating the packets, and
transmitting the aggregated packet to the arithmetic processing device;
deciding transmission timing for ACKs to a transmission source of the packets based on a flow rate for the aggregated packet; and
deciding a receive window size representing a data amount to be transmitted by one flow to the arithmetic processing device based on the flow rate for the aggregated packet.

9. The information processing apparatus according to claim 1, wherein
the memory is configured to store a reception queue,
the buffer management processing is configured to transmit the aggregated packet to the arithmetic processing device by storing, in the reception queue, the aggregated packet for a predetermined amount greater than or equal to an amount defined by the flow control;
the processing further includes:
executing a packet retrieval processing that retrieves the aggregated packet stored in the reception queue and outputs the retrieved aggregated packet to the arithmetic processing device; and
executing a data retrieval management processing that instructs the packet retrieval processing to retrieve the aggregated packet for the amount defined by the flow control from the reception queue and, when data waiting occurs in the arithmetic processing device, instructs the packet retrieval processing to retrieve the aggregated packet for an amount greater than or equal to the amount defined by the flow control.

10. The information processing apparatus according to claim 9, the processing further comprising
executing a flow control correction processing that, when retrieval of the aggregated packet for an amount greater than or equal to the amount defined by the flow control is instructed by the data retrieval management unit, corrects the flow control over the arithmetic processing device and an other arithmetic processing device such that the flow rate for the arithmetic processing device is increased and the flow rate for the other arithmetic processing device is reduced.

11. The information processing apparatus according to claim 1, wherein
the arithmetic processing device is a virtual environment, which operates on a processor in a computer, including an application and a start-up environment for the application, and
the information processing apparatus is a communication control apparatus.

12. The information processing method according to claim 7, further comprising:
transmitting the aggregated packet to the arithmetic processing device by storing, in a reception queue, the aggregated packet for a predetermined amount greater than or equal to an amount defined by flow control;
retrieving the aggregated packet for an amount defined by the flow control from the reception queue and outputting the retrieved aggregated packet to the arithmetic processing device; and
when data waiting occurs in the arithmetic processing device, retrieving the aggregated packet for an amount greater than or equal to an amount defined by the flow control from the reception queue and outputting the retrieved aggregated packet to the arithmetic processing device.

13. The non-transitory computer-readable storage medium according to claim 8, the processing further comprising:
transmitting the aggregated packet to the arithmetic processing device by storing, in a reception queue, the aggregated packet for a predetermined amount greater than or equal to an amount defined by flow control;
retrieving the aggregated packet for an amount defined by the flow control from the reception queue and outputting the retrieved aggregated packet to the arithmetic processing device; and
when data waiting occurs in the arithmetic processing device, retrieving the aggregated packet for an amount greater than or equal to an amount defined by the flow control from the reception queue and outputting the retrieved aggregated packet to the arithmetic processing device.
